(19) United States
(12) Patent Application Publication
(10) Pub. No.: US 2010/0267542 A1
(43) Pub. Date: Oct. 21, 2010

(54) SOLID-SOLUTION CARBIDE/CARBONITRIDE POWDER AND METHOD FOR PREPARING THEREOF UNDER HIGH TEMPERATURE

(75) Inventor: Shinhoo Kang, Seoul (KR)

Correspondence Address: THE NATH LAW GROUP, 112 South West Street, Alexandria, VA, 22314, US

(73) Assignee: SEOUL NATIONAL UNIVERSITY INDUSTRY FOUNDATION, Seoul (KR)

(21) Appl. No.: 12/745,822

(22) PCT Filed: Dec. 26, 2008
(86) PCT No.: PCT/KR2008/007698

§ 371 Date: Jun. 2, 2010

(30) Foreign Application Priority Data
Dec. 26, 2007 (KR) 10-2007-0137636

(51) Int. Cl. C04B 35/56; C04B 35/58

(52) U.S. Cl. 501/87; 501/96.1

(57) ABSTRACT

The present invention relates to a complete solid solution powder used for preparing a cermet composite sintered body, and method for preparing thereof under high temperature. Particularly, the present invention is directed to a complete solid solution powder which can improve, to a great extent, toughness of a cermet sintered body which is used for high-speed cutting tool materials and die materials in the field of metal working, such as various machine industries and automobile industry, and method for preparing thereof under high temperature.

### TECHNICAL FIELD

The present invention relates to a complete solid solution powder used for preparing a cermet composite sintered body, and method for preparing thereof under high temperature. Particularly, the present invention is directed to a complete solid solution powder which can improve, to a great extent, toughness of a cermet sintered body which is used for high-speed cutting tool materials and die materials in the field of metal working, such as various machine industries and automobile industry, and method for preparing thereof under high temperature.

### BACKGROUND ART

Tungsten carbide (WC)-based hard alloys, various TiC- or Ti(CN)-based cermet alloys, other ceramics or high-speed steels are used for high performance materials for cutting tools or wear-resistant tools which are essentially required in the metal cutting process or metal working process of the machine industries.

Among these, a cermet sintered body is a sintered body of ceramic-metal composite usually containing TiC or Ti(CN) as a hard phase, metals such as Ni, Co and Fe, etc. as a binder phase, as main components, and carbide, nitride or carbonitride of Group IVa, Va and VIa metals in the periodic table such as Ti, Zr, Hf, V, Nb, Ta, Cr, Mo, W, etc.

A cermet sintered body is prepared by mixing TiC or Ti(CN), etc. with a hard ceramic powder such as WC, NbC, TaC, Mo₂C, etc., and a metal powder of Co, Ni, etc. as a binder phase, and then sintering the mixture under vacuum or hydrogen atmosphere.

Among these materials, TiC has very high Vicker's hardness of 3,200 kg/mm2, a considerably high melting point of up to 3,150° C. to 3,250° C., and a relatively high oxidation resistance up to 700° C. as well as excellent properties such as wear resistance, corrosion resistance, electromagnetic radiation property, light-collecting property, etc. and, therefore, has been widely used as a substituent for WC—Co alloys which is a high-speed cutting tool material.

However, in the case of preparing a cermet sintered body using TiC as a main component, a binder metal such as Co, Ni, etc. is used as a liquid metal in the sintering process. In this case, since the wetting angle of TiC is larger than that of WC—Co combination, TiC grains grow rapidly, causing the decrease in toughness of the sintered body.

Nevertheless, a TiC—Mo₂C—Ni cermet sintered body was first mass-produced by Ford Motor Company, U.S.A. in 1956. Although this cermet sintered body was not greatly improved in toughness, it had been used as high hardness tool material for precision machining such as semi-finishing and finishing.

In the 1960's and 1970's, many attempts had been made to add various kinds of elements to the TiC—Ni cermet sintered body in order to improve toughness which was the greatest weakness thereof; however, these attempts failed to obtain significant results.

Under these circumstances, Ti(C,N) which is a thermodynamically more stable phase had been formed in the 1970's by the addition of TiN to TiC, resulting in an improvement of toughness to some extent. That is, since Ti(C,N) has a finer microstructure than TiC, toughness of Ti(C,N) could be improved compared to that of TiC, and also chemical stability and mechanical impact resistance of Ti(C,N) could be improved as well.

In addition, technological developments in the addition of WC, Mo₂C, TaC, NbC, etc. to a cermet sintered body in order to enhance the toughness thereof have been in progress such that improved cermet sintered bodies in the forms of Ti(C,N)-M₁C-M₂C— . . . —Ni/Co have been commercialized to date.

When carbides are added in order to enhance toughness of a cermet sintered body, TiC- or Ti(C,N)-based cermet sintered body has generally a microstructure of a core/rim structure in which the hard phase and rim of the core/rim structure is enclosed with a binder phase of Ni, Co, etc.

The core portion of the core/rim structure is TiC or Ti(C,N) portion which is not dissolved in a metal binder (Ni, Co, etc.) which is liquefied during sintering, and has a high hardness.

To the contrary, the rim encapsulating the core is a solid solution (designated as (Ti, M₁, M₂, . . . )(C,N)) between the core component, TiC or Ti(C,N), and the carbide added, and formed around the core, and contributes to the improvement of toughness, rather than hardness, of the cermet sintered body.

As such, the cermet solved, to an extent, the serious drawback, namely, low toughness of the conventional art by enhancing the low toughness (K_{IC}) of a simple cermet system, such as TiC—Ni or Ti(C,N)—Ni, up to 5-7 MPam^{1/2} due to the rim formed during the sintering process.

However, the cermet having the core/rim structure still had a problem that the toughness thereof was much lower than that of the conventional WC—Co cemented carbide and, thus, has not yet substituted completely for the conventional tungsten carbide-cobalt alloys (WC—Co).

As a result, attempts to develop a cermet having improved toughness through the formation of a complete solid solution phase cermet sintered body without having a core/rim structure have been continuously made by manufacturers of tools for metal working, such as Sumitomo, Mitsubishi, etc.

For example, in JP-A Showa 58-213619 (Production of powder of composite carbonitride solid solution; Publication date: Dec. 12, 1983) filed by Nippon Shinkinzoku KK, a solid solution powder was produced by mixing under wet state (a) anatase TiO₂ powder, (b) one or more oxides of, excluding Ti, group IVa (Zr, Hf), group Va (V, Nb, Ta) and group VIa (Cr, Mo, W), and one or more metals thereof, and (c) an amorphous carbon powder for 24 hours at a BPR of 5:1, and then drying the mixture; molding the desired mixture; calcining first the molded mixture under nitrogen atmosphere at 1,200° C. to 1,400° C. for more than 10 min, and then secondly at 1,700° C. to 2,000° C.; crushing the calcined molded body to obtain the solid solution powder. This method has a very complicated process so as to increase production cost. Also, it has a drawback that it is difficult to obtain complete solid solution powders by using this method since this method uses micrometer-sized powders.

In addition, in JP-A Showa 58-213619 (Manufacture of high strength cermet; Publication date: Dec. 12, 1983) filed by Mitsubishi, it was attempted to form a solid solution by pulverizing and mixing oxides of group IVa, Va and VIa metals at 1,900° C.; however, only a powder which has a core/rim structure and partially contain a solid solution phase was produced after all. The cermet sintered body obtained from such powder has a conventional core/rim structure and showed any particular properties compared with the conventional cermets.

As another prior art which uses metal oxides as starting materials for producing a cermet sintered body, U.S. Pat. No. 5,166,103 discloses a process for production of a cermet sintered body powder by reacting a mixture of WO₃, TiO₂ and C at 1,200° C. to 2,000° C. (preferably, 1,400° C. to 1,450° C.) in an electric vacuum rotary furnace. However, this US patent describes that large amount of W₂C and W was detected since the process of the US patent is a simple physical mixing process and thus phase formation is not complete. In addition, formation of a solid solution was not described in this US patent.

Moreover, U.S. Pat. No. 5,380,688 (Method for making submicrometer carbides, submicrometer solid solution carbides, and the material resulting therefrom; Date of patent: Jan. 10, 1995) of The Dow Chemical Company discloses that a single carbide such as WC, and a solid solution carbide, with a size of 0.01-1.0 μm, were made by mixing at least one oxide and carbon, and then heating the mixture as rapid as 10²-10⁸° C./sec at 1,550° C. to 1,950° C. (Table 2.).

(W,Ti)C and (W,Mo)C with hcp structure containing small amount of Ti or Mo were produced by the method disclosed in U.S. Pat. No. 5,380,688, of which the oxygent contents were considerably so high as to be 2.7 and 0.36 wt %, respectively, and changed significantly according to Examples (Example 3 and 4 in U.S. Pat. No. 5,380,688). Further, U.S. Pat. No. 5,380,688 relates to (Ti,W)C or (Ti,Mo)C with hcp structure rather than NaCl structure (fcc structure). Even when (Ti,W)C was produced by mixing oxides, the reaction did not proceed completely and, thus, a solid solution and WC (4-25%) which was not solid-solubilized were observed together with W and W₂C even in the range of solid solubility limit of WC, which demonstrates the failure of production of a complete solid solution (Examples 10, 11, 14 and 15 of U.S. Pat. No. 5,380,688). 5-20 wt % of WC and 30-40 wt % of W₂C were observed even in the production of (W,Ta)C and (W,Ti,Ta)C in U.S. Pat. No. 5,380,688 (Examples 10, 11, 14 and 15). U.S. Pat. No. 5,380,688 describes that a solid solution was easily obtained only in the case of (Ti,Ta)C.

Taking Examples 1-15 and results of composite solid solutions (Example 16-37, Table 3) described in the Dow Chemical Patent into account, when a solid solution is made from two or more oxides according to the method of U.S. Pat. No. 5,380,688, since solid solutions are formed through rapid heat-up at a rate of 10²° C./sec to 10⁸° C./sec, a mixture of two partial solid solutions, rather than a complete solid solution, is mostly formed and, therefore, a complete solid solution is not formed.

Further, U.S. Pat. No. 5,756,410 (Method for making submicrometer transition metal carbonitrides; Date of patent: May 26, 1998) of The Dow Chemical Company describes that XRD investigation reveals that all the powders made by the method of this patent consists of a carbonitride solid solution and WC (Examples 1-40 of U.S. Pat. No. 5,756,410).

Furthermore, U.S. Pat. No. 6,007,598 (Metallic-carbide-group VIII metal powder and preparation methods thereof; Date of patent: Dec. 28, 1999) of OMG Americas, Inc. describes that carbides are prepared by heating rapidly an admixture of starting materials with a heating rate of 10²-10⁸ K/sec and then adjusting a composition of the heated admixture, and heating the adjusted composition at 1,350° C.; however, all the produced powders are simple carbides, WC—Co (Examples 1-3 of U.S. Pat. No. 6,007,598), or composite powders of carbonitrides solid solution (WC—TiC—TaC) and WC—Co (Examples 4-6 of U.S. Pat. No. 6,007,598). The preparation of a complete solid solution powder is not described at all in the specification and Examples of the patent and only a composite powder consisting of a solid solution and other carbides is described.

These prior arts does not describe at all the production of a carbide solid solution powder and a cermet powder which comprises a binder phase, and employ a mixing process where starting materials are mixed in a jar lined with polyurethane at a low speed (for example, 20 rpm) without employing a crushing process.

In addition, cermet sintered body manufacturers such as Treibach, H.C. Starck, etc. produce and sell recently solid solution powders such as (W,Ti)(CN), etc.; however, XRD analyses of such powders and microstructures of sintered bodies of such powders show that such powders have not complete solid solution structures but core/rim microstructures. Consequently, carbonitride solid solution powders with a complete solid solution phase, such as (Ti,W)C, (Ti,W)(CN), etc., have not been commercialized as yet.

Moreover, Korean Patent No. 10-0528046 and US 2005/0047951 A1 (Publication date: Mar. 3, 2005) which are filed by KOREA INSTITUTE OF SCIENCE AND TECHNOLOGY, disclose a method for fabricating (Ti,TM)C—(Ni,Co) solid solution powder directly from milling the mixture of Ti, transition metal (TM), C, Ni and Co powders, and claim a method for fabricating a sintered body by sintering the (Ti,TM)C—(Ni,Co) solid solution powder. However, since this method uses metal elements as starting materials, cost of production of the solid solution powder of this method is higher compared with that of other method using metal oxides as starting materials. Also, it is difficult to commercialize this method since mass production according to this method is impossible. The above-mentioned is described in detail in “Mechanochemical synthesis of nanocomposite powder for ultra-fine (Ti,Mo)C—Ni cermet without core-rim structure”, Int. J. Ref. Met. Hard Met., 22(4-5), 2004, pp 193-196.

Besides these conventional techniques, there are many patents, such as U.S. Pat. No. 5,166,103, U.S. Pat. No. 6,793,875, etc., and papers on the production of carbides by methods similar to these conventional techniques. However, those are related to the production of carbide mixed powders, not complete solid solution powders.

General information on the production of a solid solution powder is described in Korean Patent No. 10-0626224 (solid solution powder, method to prepare the same, powder for cermet including said solid solution powder, method to prepare the same and cermet using said powder for cermet) of the present inventor, which describes a method for preparing carbide or carbonitride by mixing a said solid solution with oxides of corresponding metal elements (when nanometer-sized metal oxides are used), or mixing and crushing a said solid solution with oxides of corresponding metal elements, and then reducing, carburizing and nitriding the mixture at relatively low temperature of 1,000° C. to 1,300° C.

A sintered cermet made from the powders prepared by this method has a toughness of 9-12 MPam^{1/2} which matches toughness of tungsten carbide-cobalt alloy and, therefore, it has a market potential for a novel carbide cermet.

However, when metal oxides are used as starting materials, residual oxygen content of the solid solution produced is 0.4-1.5 wt % which is higher than <1.0 wt %, general standard value of oxygen content for commercial carbides (or carbonitrides). Also, since it is not easy to control residual oxygen content, pores are frequently formed within the microstructure of the sintered body produced by using such solid solution powder. Further, the solid solution powders cannot be inexpensively mass-produced by using an attrition mill, etc.

These problems of formation of pores within the sintered body are well demonstrated in Table 1 (oxygen content of 1.1-1.14 wt %), FIGS. 3 and 5 of Sangho PARK and Shinhoo KANG, “Toughened ultra-fine (Ti,W)(CN)Ni cermets”, Scripta Materialia, Volume 52, Issue 2, 129-133 (2005).

These problems of formation of pores within the sintered body, according to the conventional techniques, relating to this technique is also described in another paper of the present inventor, “Synthesis of (Ti,M1,M2)(CN)—Ni nanocrystalline powders, S. Park, Y. J. Kang, H. J. Kwon and S. Kang, International Journal of Refractory Metals & Hard Materials, 24, 115121 (2006), and “Sintered (Ti,W)C carbides”, J. Jung and S. Kang, Scripta Materialia, 56, 561-564 (2007).

Consequently, since, according to a method for producing a solid solution powder by using metal oxides as a starting material by the conventional technique, size of powder crystallites obtained thereby is small, process temperature is low, and manufacturing process is simple, the method has a considerable market potential and competitive power for tungsten carbide cobalt-alloy. However, it is difficult to obtain a sintered body which can be produced with low cost and has a microstructure with low porosity. Up to now, a method for producing a complete solid solution powder which is commercially mass-producible and of which oxygen and carbon contents are easily controllable, has not yet been developed. A fabricating technology of a sintered body by using such powder for producing a cermet for cutting tools, has not yet been developed either.

### DISCLOSURE

### Technical Problem

The present invention is to provide a novel method for preparing a solid solution powder for a cermet sintered body, which makes it possible to manufacture a high performance cutting tool. In particular, the object of the present invention is to solve the above-mentioned problems of the prior art and to provide a novel method for controlling an oxygen and carbon content of the powder for a cermet sintered body and preparing such powder in a large quantity.

In order to solve a problem that the conventional TiC- and Ti(CN)-based cermet have low toughness in spite of their high hardness, the present invention is to provide a novel method for minimizing an amount of oxygen residing within the powder for a cermet sintered body by making it easier a procedure of removing oxygen from metal oxide through reduction, when producing a complete solid solution powder without a core/rim structure by using metal oxide as a starting material.

Since residual oxygen content of the powder for a cermet sintered body, prepared by the method of the present invention, is small, possibility of the formation of pores during sintering the powder for a cermet sintered body can be minimized, thereby substantially improving toughness of the powder for a cermet sintered body to a great extent as well as general mechanical properties thereof. In addition, when a cermet sintered body is prepared by using the carbonitride solid solution powder of the present invention, an amount of tungsten being used decreases and, therefore, cost of raw materials can be curtailed and manufacturing process can be considerably simplified.

### Technical Solution

The primary object of the present invention can be achieved by providing a complete solid solution powder prepared by the steps comprising: i) step 1 of mixing, or mixing and grinding at least two metals, including Ti, selected from the group consisting of Ti, Zr, Hf, V, Nb, Ta, Cr, Mo and W, oxides of the at least two metals, and carbon powder; and ii) step 2 of reducing and carburizing, or reducing, carburizing and nitriding the mixed, or mixed and ground powder.

In the complete solid solution powder of the present invention, the powder is preferably reduced and carburized at 1,300° C. to 2,200° C. for less than 3 hours under vacuum or hydrogen atmosphere to produce a complete solid solution carbide, or the powder is preferably reduced, carburized and nitrided at 1,300° C. to 2,200° C. for less than 3 hours under nitrogen atmosphere to produce a complete solid solution carbonitride, at the step 2.

Another object of the present invention can be achieved by providing a sintered body prepared by the steps comprising: i) step 1 of mixing, or mixing and grinding at least two metals, including Ti, selected from the group consisting of Ti, Zr, Hf, V, Nb, Ta, Cr, Mo and W, oxides of the at least two metals, and carbon powder; ii) step 2 of reducing and carburizing, or reducing, carburizing and nitriding the mixed, or mixed and ground powder; and iii) step 3 of compacting and sintering the complete solid solution powder obtained at the step 2.

In the sintered body of the present invention, the powder is preferably reduced and carburized at 1,300° C. to 2,200° C. for less than 3 hours under vacuum or hydrogen atmosphere to produce a complete solid solution carbide, or the powder is preferably reduced, carburized and nitrided at 1,300° C. to 2,200° C. for less than 3 hours under nitrogen atmosphere to produce a complete solid solution carbonitride, at the step 2.

In addition, in the sintered body of the present invention, the complete solid solution powder is preferably sintered at 1,250° C. to 1,600° C. for 0.1 to 3 hours under vacuum or nitrogen atmosphere at the step 3.

Yet another object of the present invention can be achieved by providing a cermet powder prepared by the steps comprising: i) step 1-2 of mixing, or mixing and grinding at least one oxide selected from the group consisting of nickel, cobalt and iron, at least two metals, including Ti, selected from the group consisting of Ti, Zr, Hf, V, Nb, Ta, Cr, Mo and W, oxides of the at least two metals, and carbon powder; and ii) step 2-2 of reducing and carburizing, or reducing, carburizing and nitriding the mixed, or mixed and ground powder.

In the cermet powder of the present invention, the powder is preferably reduced and carburized at 1,100° C. to 1,400° C. for less than 3 hours under vacuum or hydrogen atmosphere to produce a complete solid solution carbide, or the powder is preferably reduced, carburized and nitrided at 1,100° C. to 1,400° C. for less than 3 hours under nitrogen atmosphere to produce a complete solid solution carbonitride, at the step 2-2.

Further another object of the present invention can be achieved by providing a cermet prepared by the steps comprising: i) step 1-2 of mixing, or mixing and grinding an oxide of at least one selected from the group consisting of nickel, cobalt and iron, at least two metals, including Ti, selected from the group consisting of Ti, Zr, Hf, V, Nb, Ta, Cr, Mo and W, oxides of the at least two metals, and carbon powder; ii) step 2-2 of reducing and carburizing, or reducing, carburizing and nitriding said mixed, or mixed and ground powder; and iii) step 2-3 of compacting and sintering the cermet powder obtained at the step 2-2.

In the cermet of the present invention, the powder is preferably reduced and carburized at 1,100° C. to 1,400° C. for less than 3 hours under vacuum or hydrogen atmosphere to produce a complete solid solution carbide, or the powder is preferably reduced, carburized and nitrided at 1,100° C. to 1,400° C. for less than 3 hours under nitrogen atmosphere to produce a complete solid solution carbonitride, at the step 2-2.

In the cermet of the present invention, the cermet powder is preferably sintered at 1,250° C. to 1,600° C. for 0.1 to 3 hours under vacuum or nitrogen atmosphere at the step 2-3.

Still another object of the present invention can be achieved by providing a cermet powder prepared by the steps comprising: i) mixing, or mixing and grinding at least two metals, including Ti, selected from the group consisting of Ti, Zr, Hf, V, Nb, Ta, Cr, Mo and W, oxides of said at least two metals, and carbon powder; ii) reducing and carburizing, or reducing, carburizing and nitriding said mixed, or mixed and ground powder to prepare a complete solid solution powder; and iii) adding at least one metal selected from the group consisting of nickel, cobalt and iron to said complete solid solution powder.

In the cermet powder of the present invention, the powder is preferably reduced and carburized at 1,300° C. to 2,200° C. for less than 3 hours under vacuum or hydrogen atmosphere to produce a complete solid solution carbide, or the powder is preferably reduced, carburized and nitrided at 1,300° C. to 2,200° C. for less than 3 hours under nitrogen atmosphere to produce a complete solid solution carbonitride, at the step ii).

Still another object of the present invention can be achieved by providing a method for preparing a cermet comprising: i) mixing, or mixing and grinding at least two metals, including Ti, selected from the group consisting of Ti, Zr, Hf, V, Nb, Ta, Cr, Mo and W, oxides of the at least two metals, and carbon powder; ii) reducing and carburizing, or reducing, carburizing and nitriding the mixed, or mixed and ground powder to prepare a complete solid solution powder; iii) adding at least one metal selected from the group consisting of nickel, cobalt and iron to the complete solid solution powder; and iv) compacting and sintering the cermet powder obtained from the step iii).

In the method for preparing a cermet of the present invention, the powder is preferably reduced and carburized at 1,300° C. to 2,200° C. for less than 3 hours under vacuum or hydrogen atmosphere to produce a complete solid solution carbide, or the powder is preferably reduced, carburized and nitrided at 1,300° C. to 2,200° C. for less than 3 hours under nitrogen atmosphere to produce a complete solid solution carbonitride, at the step ii).

In addition, in the method for preparing a cermet of the present invention, the complete solid solution powder is preferably sintered at 1,250° C. to 1,600° C. for 0.1 to 3 hours under vacuum or nitrogen atmosphere at the step iv).

Still another object of the present invention can be achieved by providing a method for preparing a complete solid solution powder comprising: i) step 1 of mixing, or mixing and grinding at least two metals, including Ti, selected from the group consisting of Ti, Zr, Hf, V, Nb, Ta, Cr, Mo and W, oxides of the at least two metals, and carbon powder; and ii) step 2 of reducing and carburizing, or reducing, carburizing and nitriding the mixed, or mixed and ground powder.

In the method for preparing a complete solid solution powder of the present invention, the powder is preferably reduced and carburized at 1,300° C. to 2,200° C. for less than 3 hours under vacuum or hydrogen atmosphere to produce a complete solid solution carbide, or the powder is preferably reduced, carburized and nitrided at 1,300° C. to 2,200° C. for less than 3 hours under nitrogen atmosphere to produce a complete solid solution carbonitride, at the step 2.

Still another object of the present invention can be achieved by providing a method for preparing a cermet powder comprising: i) step 1-2 of mixing, or mixing and grinding at least one oxide selected from the group consisting of nickel, cobalt and iron, at least two metals, including Ti, selected from the group consisting of Ti, Zr, Hf, Nb, Ta, Cr, Mo and W, oxides of the at least two metals, and carbon powder; and ii) step 2-2 of reducing and carburizing, or reducing, carburizing and nitriding the mixed, or mixed and ground powder.

In the method for preparing a cermet powder of the present invention, the powder is preferably reduced and carburized at 1,100° C. to 1,400° C. for less than 3 hours under vacuum or hydrogen atmosphere to produce a complete solid solution carbide, or the powder is preferably reduced, carburized and nitrided at 1,100° C. to 1,400° C. for less than 3 hours under nitrogen atmosphere to produce a complete solid solution carbonitride, at the step 2-2.

Still another object of the present invention can be achieved by providing a method for preparing a cermet powder comprising: i) mixing, or mixing and grinding at least two metals, including Ti, selected from the group consisting of Ti, Zr, Hf, V, Nb, Ta, Cr, Mo and W, oxides of the at least two metals, and carbon powder; ii) reducing and carburizing, or reducing, carburizing and nitriding the mixed, or mixed and ground powder to prepare a complete solid solution powder; and iii) adding at least one metal selected from the group consisting of nickel, cobalt and iron to the complete solid solution powder.

In the method for preparing a cermet powder of the present invention, the powder is preferably reduced and carburized at 1,300° C. to 2,200° C. for less than 3 hours under vacuum or hydrogen atmosphere to produce a complete solid solution carbide, or the powder is preferably reduced, carburized and nitrided at 1,300° C. to 2,200° C. for less than 3 hours under nitrogen atmosphere to produce a complete solid solution carbonitride, at the step ii).

The complete solid solution powder for a cermet sintered body, the cermet powder comprising the complete solid solution powder, and the cermet sintered body prepared by using the cermet powder, according to the present invention, contain a complete solid solution, and volume fraction of the solid solution phase remarkably increases (>70%), in comparison with the total volume of the alloy. Therefore, toughness of the cermet sintered body provided by the present invention greatly increases.

In addition, according to the method for preparing a solid solution powder and a method for preparing the cermet powder of the present invention, a powder with a uniform microstructure with only a complete solid solution phase, rather than a core/rim structure of the sintered body of the conventional powder for a cermet sintered body, can be prepared through mixing, or mixing and grinding at least two metals, including Ti, selected from the group consisting of Ti, Zr, Hf, V, Nb, Ta, Cr, Mo and W, oxides of the at least two metals, and carbon powder, and then reducing and carburizing, or reducing, carburizing and nitriding the mixed, or mixed and ground powder. Also, a cermet sintered body can be provided by directly sintering the complete solid solution powder of the present invention, without additional mixing step.

A powder with a uniform microstructure with only a complete solid solution phase, rather than a core/rim structure of the sintered body of the conventional powder for a cermet sintered body, can be prepared through mixing, or mixing and grinding at least two metals, including Ti, selected from the group consisting of Ti, Zr, Hf, V, Nb, Ta, Cr, Mo and W, oxides of the at least two metals, and carbon powder, and then reducing and carburizing, or reducing, carburizing and nitriding the mixed, or mixed and ground powder, and a cermet sintered body is prepared by mixing such solid solution powder with a nickel, iron or cobalt powder and then sintering the mixture.

Moreover, according to the method for preparing a complete solid solution powder of the present invention, especially when forming a carbonitride, the amounts of oxygen, carbon and nitrogen are suitably controlled through reducing and carburizing the mixed, or mixed and ground powder and then nitriding the reduced and carburized powder at temperature of 1,300° C. to 2,200° C., so as to have the technical effect of preventing the cermet sintered body from pores and improving other mechanical properties thereof.

According to the present invention, a carbide or carbonitride solid solution powder with a complete solid solution phase is prepared through the steps of mixing at least two metals, including Ti, selected from the group consisting of Ti, Zr, Hf, V, Nb, Ta, Cr, Mo and W, oxides of the at least two metals, and carbon powder, and, if necessary, grinding the mixture by high energy ball milling, and then reducing, carburizing and/or nitriding the mixture.

That is, according to the present invention, at least two metals, including Ti, selected from the group consisting of Ti, Zr, Hf, V, Nb, Ta, Cr, Mo and W, oxides of the at least two metals, for example, Ti, W, Mo, Ta, Nb, TiO₂, WO₃, MoO, TaO, NbO, etc., and carbon powder are mixed, or mixed and ground (step 1) in order to prepare a TiC-based solid solution powder.

In addition, according to the present invention, for example, at least one selected from the group consisting of nickel, cobalt and iron, or oxide thereof; at least one metal selected from the group IVa, Va and VIa metals, and oxide of the at least one metal, such as Ti, W, Mo, Ta, Nb, TiO₂, WO₃, MoO, TaO, NbO, etc.; and carbon powder are mixed, or mixed and ground (step 1-2) in order to prepare a powder for a cermet sintered body.

In the step 1-2, the mixture ratio between at least two metals, including Ti, selected from the group consisting of Ti, Zr, Hf, V, Nb, Ta, Cr, Mo and W can be selected based on the desired composition of the solid solution. Additionally, a high energy ball mill, such as an attrition mill, etc., may be used in the grinding process.

The solid solution powder with a complete solid solution phase can be easily provided by the present invention through such ball milling procedure.

TiC-based solid solution powder with a complete solid solution phase can be prepared by reducing and carburizing the mixed and/or ground powder, for example under vacuum or hydrogen atmosphere (step 2). The oxygen content of the thus prepared carbide powder plays a very important role in the next sintering procedure. Since increase of the oxygen content generally tends to form pores, it is necessary to control properly or minimize the oxygen content.

Therefore, the mixed and/or ground powder is reduced and carburized under vacuum or hydrogen atmosphere at 1,300° C. to 2,200° C. for not exceeding 3 hours, depending on degree of grinding. As a result, the reduced and carburized powder has similar oxygen content to a cermet powder which is commercially available at present, and thus helps to enhance physical properties of the cermet sintered body.

In order to prepare Ti(CN)-based solid solution powder, nitrogen is injected into a vacuum furnace during heating the mixed and/or ground powder (step 1) under vacuum, and then the reduction, carburization and nitriding of the mixed and/or ground powder simultaneously take place at 1,300° C. to 2,200° C. for not exceeding 3 hours. Then, Ti(CN)-based solid solution powder with a complete solid solution phase is provided (step 2).

The oxygen content of the thus prepared carbonitride powder is also very important. Since increase of the oxygen content generally tends to form pores, it is necessary to minimize the oxygen content and control properly the carbon and nitrogen content.

Consequently, the mixed and/or ground powder is reduced, carburized and nitrided under vacuum, or hydrogen and nitrogen atmosphere at 1,300° C. to 2,200° C. for not exceeding 3 hours, depending on degree of grinding. The residual oxygen content of the solid solution powder for a cermet sintered body prepared by the method of the present invention is much less than that of a solid solution powder according to the conventional art.

The nitrogen content of the complete solid solution of the present invention may be controllable based on a process temperature, a partial pressure of nitrogen during powder synthesis and an amount of carbon added to the powder. Especially, carbon/nitrogen (molar ratio) is preferably 3/7, 5/5, or 7/3 for a stable composition.

In order to prepare a cermet powder by using the solid solution powder of the present invention, a binder metal such as nickel, cobalt, iron or nickel/cobalt, etc. is mixed, or mixed and ground (step 1-2).

The cermet powder is provided by reducing and carburizing under vacuum or hydrogen atmosphere, or reducing, carburizing and nitriding the mixed and/or ground powder under vacuum or hydrogen and nitrogen atmosphere at 1,100° C. to 1,400° C. for not exceeding 3 hours, depending on the degree of grinding.

TiC- or Ti(CN)-based cermet sintered body with complete solid solution phase is prepared by sintering the cermet powder of the present invention under vacuum at an ordinary sintering temperature for an ordinary sintering time.

As described above, a complete solid solution powder having desired compositions of (Ti,M1,M2, . . . )C and (Ti,M1,M2, . . . )(C,N) which have not a core/rim structure, a cermet powder comprising the complete solid solution powder, and a cermet sintered body prepared from the cermet powder can be produced according to the present invention.

The sizes of the powders may be controlled by regulating the grinding conditions such as time, rate, temperature, etc., and synthesis conditions such as time, temperature, etc. Nanometer-sized, submicrometer-sized (more than 100 nm, less than 1 μm) and micrometer-sized complete solid solution powders and cermet powders can be prepared according to the method of the present invention.

Fabricating facilities and processes for the conventional cermet powder with the size of more than submicrometer, had already been commercialized. Since the complete solid solution of the present invention not having a core/rim structure can be prepared in the fabricating facilities for the conventional cermet powder, the methods of the present invention are easily applicable to the existing facilities and also economical.

### DESCRIPTION OF DRAWINGS

FIG. 1 illustrates graphs of X-ray diffraction (XRD) phase analysis results of the powders prepared by grinding the mixture of Ti, anatase TiO₂, WO₃ and C in which the ratio of TiO₂:Ti are (a) 1:0 and (b) 1:1, respectively, according to Example 1 of the present invention.

FIG. 2 illustrates graphs of XRD phase analysis results of the (Ti_{0.7}W_{0.3})C solid solution powders prepared by carburizing and reducing the powders of FIG. 1(a) and FIG. 1(b) in a graphite vacuum furnace at 1,300° C., 1,400° C. and 1,500° C. for 2 hours, and at 1,600° C. for 1 hour, according to Example 1 of the present invention.

FIG. 3 illustrates graphs of XRD phase analysis results of the (Ti_{0.7}W_{0.3})(CN) solid solution powders prepared by reducing and carbonitriding the powders of FIG. 1(a) and FIG. 1(b) in a graphite vacuum furnace at nitrogen pressure of 10 torr at a temperature range of 1,300° C. to 1,500° C. for 2 hours, according to Example 2 of the present invention.

FIG. 4 illustrates graphs of XRD phase analysis results of the (Ti_{0.7}W_{0.3})(CN) solid solution powders prepared by reducing and carbonitriding the powders of FIG. 1(a) and FIG. 1(b) in a graphite vacuum furnace at nitrogen pressure of 10 torr at 1,800° C. and 2,000° C. for 1 hour, according to Example 3 of the present invention.

FIG. 5 illustrates optical microscopic and FESEM (field emission scanning microscopy) images of the microstructures of the (Ti_{0.7}W_{0.3})C-20 wt % Ni cermet sintered bodies which were produced by using the (Ti_{0.7}W_{0.3})C solid solution powders prepared by mixing and grinding TiO₂, WO₃ and C followed by reducing and carburizing the mixed and ground powders at 1,400° C. and 1,500° C. for 2 hours, according to Example 4 of the present invention.

FIG. 6 illustrates optical microscopic and FESEM (field emission scanning microscopy) images of the microstructures of the (Ti_{0.7}W_{0.3})(CN)-20 wt % Ni cermet sintered bodies which were produced by using the (Ti_{0.7}W_{0.3})(CN) solid solution powders prepared by mixing and grinding (a) TiO₂, WO₃ and C, and (b) Ti, TiO₂, WO₃ and C (TiO₂:Ti=1:1) followed by reducing, carburizing and nitriding the mixed and ground powders at 1,400° C. and 1,500° C. for 2 hours, according to Example 5 of the present invention.

FIG. 7 illustrates XRD results of the (Ti_{0.7}W_{0.3})(CN)-20 wt % Ni cermet sintered bodies which were produced by using the (Ti_{0.7}W_{0.3})(CN) solid solution powders prepared according to Example 6 of the present invention.

FIG. 8 illustrates optical microscopic images of the microstructures of the (Ti_{0.7}W_{0.3})(CN)-20 wt % Ni cermet sintered bodies which were produced by using the (Ti_{0.7}W_{0.3})(CN) solid solution powders prepared according to Example 6 of the present invention.

FIG. 9 illustrates optical microscopic images of the microstructures of the (Ti₁₋ₓWₓ)C-15˜20 wt % Ni cermet sintered bodies which were produced by using the (Ti_{0.7}W_{0.3})C and (Ti_{0.88}W_{0.12})C solid solution powders prepared according to Example 7 of the present invention.

FIG. 10 illustrates optical microscopic images of the microstructures of the (Ti₁₋ₓWₓ)(CN)-15˜20 wt % Ni cermet sintered bodies which were produced by using the (Ti_{0.7}W_{0.3})(CN) and (Ti_{0.88}W_{0.12})(CN) solid solution powders prepared according to Example 8 of the present invention.

FIG. 11 illustrates graphs of XRD phase analysis results of the powders prepared by mixing Ti, anatase TiO₂, WO₃ and C powders in which the ratio of TiO₂:Ti is 4:1, and grinding the mixture in a planetary mill for 5, 10 and 20 hours, respectively, according to Example 9 of the present invention.

FIG. 12 illustrates XRD results of the powders prepared by mixing Ti, anatase TiO₂, WO₃ and C powders in which the ratio of TiO₂:Ti is 4:1, grinding the mixture in a planetary mill for 5, 10 and 20 hours, respectively, and carburizing and reducing the ground powders in a graphite vacuum furnace at 1,300° C. for 2 hours, according to Example 9 of the present invention.

FIG. 13 illustrates XRD results of the powders prepared by mixing Ti, anatase TiO₂, WO₃ and C powders in which the ratio of TiO₂:Ti is 4:1, grinding the mixture in a planetary mill for 5, 10 and 20 hours, respectively, and carburizing and reducing the ground powders in a graphite vacuum furnace at 1,400° C. for 2 hours, according to Example 9 of the present invention.

FIG. 14 illustrates XRD results of the powders prepared by mixing Ti, anatase TiO₂, WO₃ and C powders in which the ratio of TiO₂:Ti is 4:1, grinding the mixture in a planetary mill for 5, 10 and 20 hours, respectively, and carburizing and reducing the ground powders in a graphite vacuum furnace at 1,500° C. for 2 hours, according to Example 9 of the present invention.

FIG. 15 illustrates XRD results of the powders prepared by mixing Ti, anatase TiO₂, WO₃ and C powders in which the ratio of TiO₂:Ti is 4:1, grinding the mixture in a planetary mill for 5, 10 and 20 hours, respectively, and carburizing and reducing the ground powders in a graphite vacuum furnace at 1,600° C. for 2 hours, according to Example 9 of the present invention.

FIG. 16 illustrates SEM images of the microstructures of the sintered bodies prepared by sintering the (Ti_{0.7}W_{0.3})C-20 wt % Ni cermet powders at 1,510° C. for 1 hour under vacuum, according to Example 10 of the present invention.

FIG. 17 illustrates SEM images of the microstructures of the sintered bodies prepared by sintering the (Ti_{0.7}W_{0.3})C-20 wt % Ni cermet powders at 1,400° C. for 1 hour under vacuum, according to Example 10 of the present invention.

### BEST MODE

Hereinafter, the present invention will be described in greater detail with reference to the following examples. The examples are given only for illustration of the present invention and not to be limiting the present invention. The following examples are intended to complete the disclosure of the present invention and to easily embody the present invention by those skilled in the art. Furthermore, it can be understood by those skilled in the art that the following examples may be variously modified within the accompanying claims.

### Example 1

In order to produce a complete solid solution with the composition of (Ti_{0.7}W_{0.3})C, Ti metal, anatase TiO₂, WO₃ and carbon powder were prepared. Two mixtures in which the mixture ratios of TiO₂ and Ti were 1:0 or 1:1, respectively, were prepared, and WO₃ and carbon powder were mixed therewith. The thus prepared two mixtures were ground in an attrition mill, using WC—Co balls, at 250 rpm and with BPR (ball-to-powder ratio) of 30:1, in a dry state for 20 hours, and then were reduced and carburized by heat-treatment at 1,300° C. to 1,500° C. for 2 hours, and at 1,600° C. for 1 hour under vacuum.

Considering that most reduction procedures proceed with the emission of CO gases, the amount of carbon being added was determined based on the calculation that 3 moles carbon per 1 mole TiO₂ is required when TiO₂ is used to produce carbide, and 1 mole carbon per 1 mole Ti is required when Ti is used to produce carbide. The weights of raw materials used to prepare the target composition of (Ti_{0.7}W_{0.3})C are listed in Table 1.

TABLE 1

| | |
|---|---|
| TiO₂:Ti | raw materials (g/batch) |

| weight ratio | TiO₂ | Ti | WO₃ | C |
|---|---|---|---|---|
| 1:0 | 33.865 | 0 | 42.125 | 24.01 |
| 1:1 | 14.908 | 14.908 | 49.465 | 20.717 |

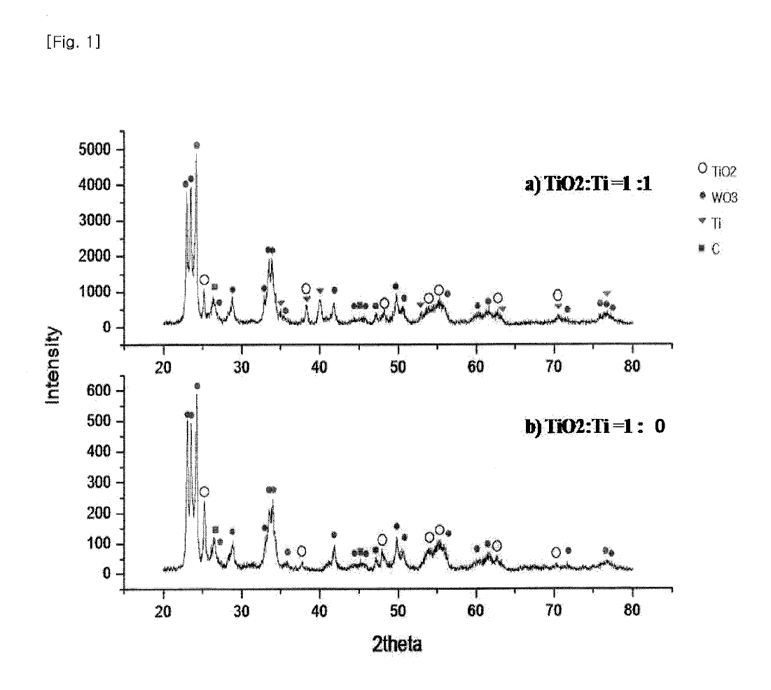

FIG. 1 illustrates graphs of X-ray diffraction (XRD) phase analysis results of the powders prepared by grinding the mixture of Ti, anatase TiO₂, WO₃ and C in which the ratio of TiO₂:Ti are (a) 1:0 and (b) 1:1, respectively, according to Example 1 of the present invention.

FIG. 1(a) shows that each phase is still present after grinding the mixture of TiO₂, WO₃ and C (TiO₂:Ti=1:0). Considering the decrease of the peak intensity of each phase in FIG. 1, it can be understood that the oxides became as small as a nanocrystallite.

FIG. 1(b) shows XRD phase analysis results of the powders prepared by grinding the mixture of Ti, TiO₂, WO₃ and C (TiO₂:Ti=1:1). Similar to the result of FIG. 1(a), it can be seen that each phase of Ti, TiO₂, WO₂ and C is still present, and the peak intensity of each phase is relatively higher than that of FIG. 1(a).

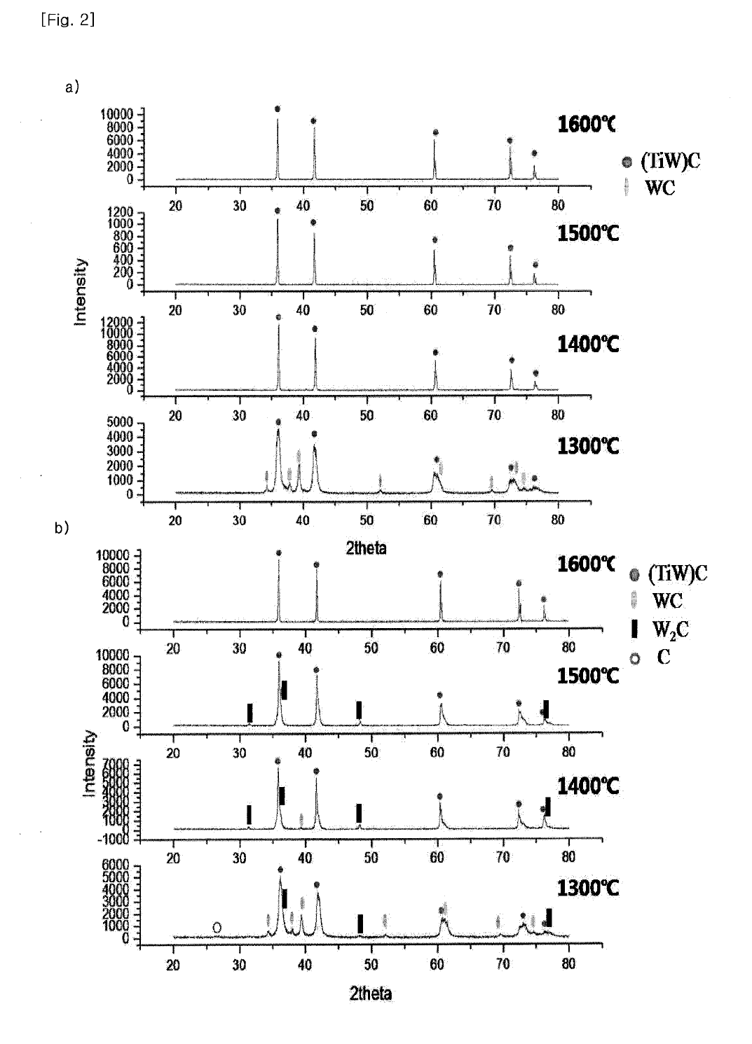

FIG. 2 is XRD phase analysis results of the powders prepared by carburizing and reducing the powders of FIG. 1 in a graphite vacuum furnace at 1,300° C., 1,400° C. and 1,500° C. for 2 hours, and at 1,600° C. for 1 hour.

FIG. 2(a) is the XRD results of the mixture powders of anatase TiO₂, WO₃ and C (TiO₂:Ti=1:0) and shows that the (Ti_{0.7}W_{0.3})C complete solid solutions were formed at all temperatures in the range of 1,300° C. to 1,600° C. However, it can be understood that W₂C phase was also formed in the powder carburized and reduced at a relatively low temperature of 1,300° C. and, however, disappeared with increase of the carburization and reduction temperature.

FIG. 2(b) is the XRD results of the mixture powders of Ti, anatase TiO₂, WO₃ and C (TiO₂:Ti=1:1) and shows that the (Ti_{0.7}W_{0.3})C complete solid solutions were formed at all temperatures in the range of 1,300° C. to 1,600° C. It can be observed from the XRD results at 1,300° C. that WC, W₂C and free carbon are present. However, it can be known that as the carburization and reduction temperature increases more than 1,400° C., WC, W₂C and free carbon gradually disappear and, finally, the complete solid solution is formed at a temperature of more than 1,600° C.

The oxygen and carbon contents of the powders prepared by using two compositions and process of Example 1 are shown in Table 2. When reducing and carburizing at temperatures of more than 1,400° C. for 2 hours, the residual oxygen is so low as to be less than 0.5 wt %. In addition, carburization and reduction time decreases with increase of temperature.

TABLE 2

| | carbon content (oxygen content) | | | |
|---|---|---|---|---|
| | 1,300° C., | 1,400° C., | 1,500° C., | 1,600° C., |
| raw materials | 2 hr | 2 hr | 2 hr | 1 hr |
| TiO₂ + WO₃ + C | 11.12 (1.48) | 11.54 (0.445) | 11.16 (0.0613) | 11.05 (0.0389) |
| TiO₂ + Ti + WO₃ + | 12.30 (1.99) | 11.80 (0.544) | 11.70 (0.389) | 11.59 (—) |
| C (TiO₂:Ti = 1:1) | | | | |

It can be known from Example 1 that a complete solid solution such as (Ti_{0.7}W_{0.3})C can be easily obtained when the mixed oxide powders ground in an attrition mill are reduced and carburized at a temperature of more than 1,300° C. for more than 2 hours. In the case of reduction and carburization at more than 1,400° C. for more than 2 hours, or at more than 1,600° C. for 1 hour, the amount of residual oxygen is very low (<0.5 wt %) and carbon content can be appropriately maintained. Therefore, even when utilizing a grinder which provides ununiform grinding results, such as an attrition mill, a complete solid solution powder with a very low residual oxygen can be prepared by controlling an amount of carbon and carrying out reduction and carburization at more than 1,400° C. Accordingly, a solid solution powder can be prepared at a wide range of temperature of 1,300° C. to 2,200° C. Moreover, when using an attrition mill, it becomes easy to control oxygen and carbon contents and carry out grinding process by using Ti together with TiO₂ rather than using only TiO₂.

### Example 2

In order to produce a complete solid solution with the composition of (Ti_{0.7}W_{0.3})(CN), Ti metal, anatase TiO₂, WO₃ and carbon powder were prepared. Two mixtures in which the mixture ratios of TiO₂ and Ti were 1:0 or 1:1, respectively, were prepared, and WO₃ and carbon powder were mixed therewith. The thus prepared two mixtures were ground in an attrition mill, using WC—Co balls, at 250 rpm and with BPR (ball-to-powder ratio) of 30:1, in a dry state for 20 hours. Then, the ground powders were reduced and carbonitrided by heat-treatment at 1,300° C. to 1,500° C. for 2 hours, and at 1,600° C. for 1 hour under vacuum. The amount of carbon used was the same as in Example 1, and the weights of raw materials used in Example 2 for preparing (Ti_{0.7}W_{0.3})(CN) are the same as in Table 1.

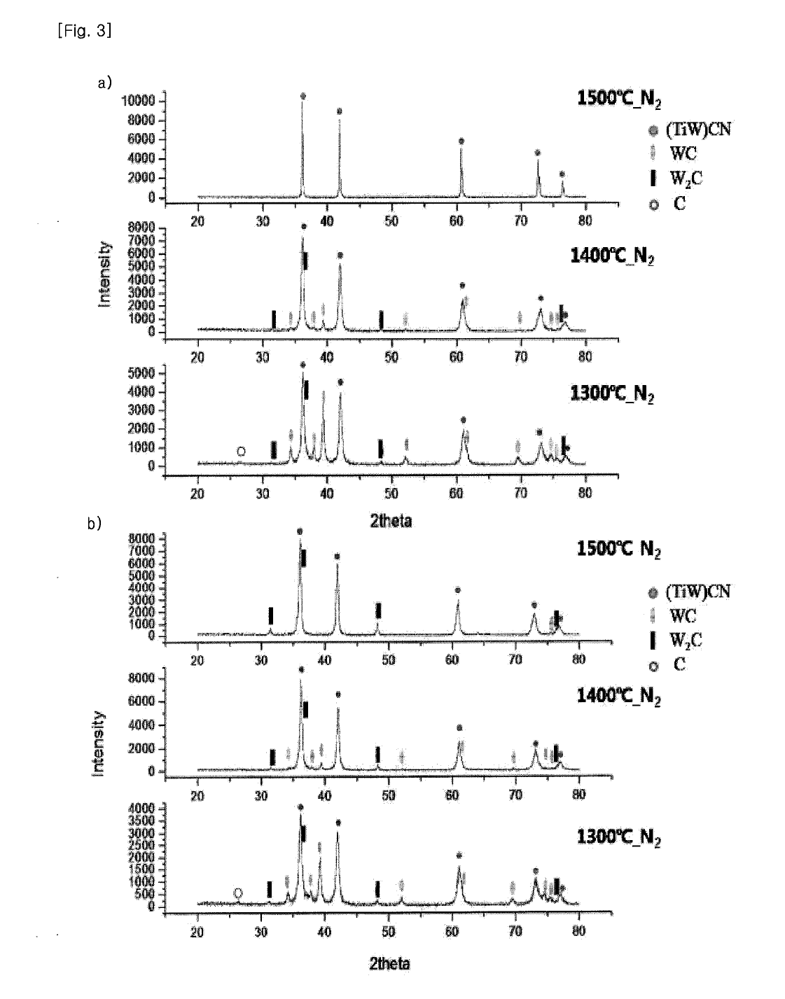

FIG. 3 illustrates XRD results of the powders prepared by reducing and carbonitriding the powders of FIG. 1(a) and FIG. 1(b) in a graphite vacuum furnace at a temperature range of 1,300° C. to 1,500° C. for 2 hours.

FIG. 3(a) illustrates XRD results of the powders prepared by using anatase TiO₂, WO₃ and carbon powder (TiO₂:Ti=1:0), and shows that (Ti_{0.7}W_{0.3})(CN) complete solid solutions were formed at all temperatures of 1,300° C. to 1,500° C. However, WC was formed at 1,300° C., together with W₂C. At 1,400° C., formation of WC and W₂C gradually decreased, and at 1,500° C., (Ti,W)(CN) complete solid solutions were obtained without formation of WC and W₂C.

FIG. 3(b) illustrates XRD results of the powders prepared by using Ti, anatase TiO₂, WO₃ and carbon powder (TiO₂:Ti=1:1), and shows that (Ti_{0.7}W_{0.3})(CN) complete solid solutions were formed at all temperatures of 1,300° C. to 1,500° C., as in FIG. 3(a). However, in these cases, WC was formed even at 1,500° C., and even free carbon besides WC and W₂C was observed at 1,300° C. The formation of WC and W₂C increased with increase of temperature, as in FIG. 3(a).

Table 3 shows the oxygen, nitrogen and carbon contents of the powders prepared by using the above-mentioned compositions and carbonitriding process. The oxygen content was below 1.0 wt % at more than 1,400° C. and below 0.5 wt % at 1,500° C. Overall oxygen, nitrogen and carbon contents decreased with increase of temperature. In addition, the oxygen and carbon contents of the compositions containing TiO₂ together with Ti were larger than those of the compositions containing TiO₂ without Ti.

It can be known from Example 2 that a complete solid solution such as (Ti_{0.7}W_{0.3})(CN) can be easily obtained by reducing and carbonitring at more than 1,300° C. for more than 2 hours. Further, even when utilizing a grinder which provides ununiform grinding results, such as an attrition mill as in Example 1, a solid solution which is usable can be prepared by controlling an amount of carbon and carrying out reduction and carbonitridation at more than 1,300° C. Consequently, carbonitride solid solution powders can be prepared at a temperature range of 1,300° C. to 2,200° C., at which a graphite electric furnace operates. It can be also known from Example 2 that, in the case of preparation of carbonitrides, homogenizing temperature of a carbonitride are higher than that of carbide due to a disaffinity between W and nitrogen.

TABLE 3

| | carbon content (oxygen content) | | | |
|---|---|---|---|---|
| | 1,300° C., | 1.400° C., | 1,500° C., | 1,600° C., |
| raw materials | 2 hr | 2hr | 2 hr | 1 hr |
| TiO₂ + WO₃ + C | 10.88 (1.64) | 10.55 (0.821) | 10.79 (0.074) | — |
| | (Ti_{0.7}W_{0.3})(C_{0.77}N_{0.23}) | (Ti_{0.7}W_{0.3})(C_{0.79}N_{0.21}) | (Ti_{0.7}W_{0.3})(C_{0.84}N_{0.16}) | — |
| TiO₂ + Ti + WO₃ + | 12.13 (1.75) | 11.65 (0.862) | 11.49 (0.242) | — |
| C (TiO₂:Ti = 1:1) | (Ti_{0.7}W_{0.3})(C_{0.74}N_{0.26}) | (Ti_{0.7}W_{0.3})(C_{0.77}N_{0.23}) | (Ti_{0.7}W_{0.3})(C_{0.81}N_{0.19}) | — |

### Example 3

In order to produce a complete solid solution with the composition of (Ti_{0.7}W_{0.3})(CN), anatase TiO₂, WO₃ and carbon powder were prepared and mixed. The thus prepared mixture was ground in an attrition mill, using WC—Co balls, at 250 rpm and with BPR (ball-to-powder ratio) of 30:1, in a dry state for 20 hours. Then, the ground powders were reduced and carbonitrided by heat-treatment at 1,800° C. and 2,000° C. for 1 hour at a nitrogen pressure of 10 torr. The amount of carbon used was the same as in Example 1, and the weights of raw materials used in Example 3 for preparing (Ti_{0.7}W_{0.3})(CN) are the same as in Table 1.

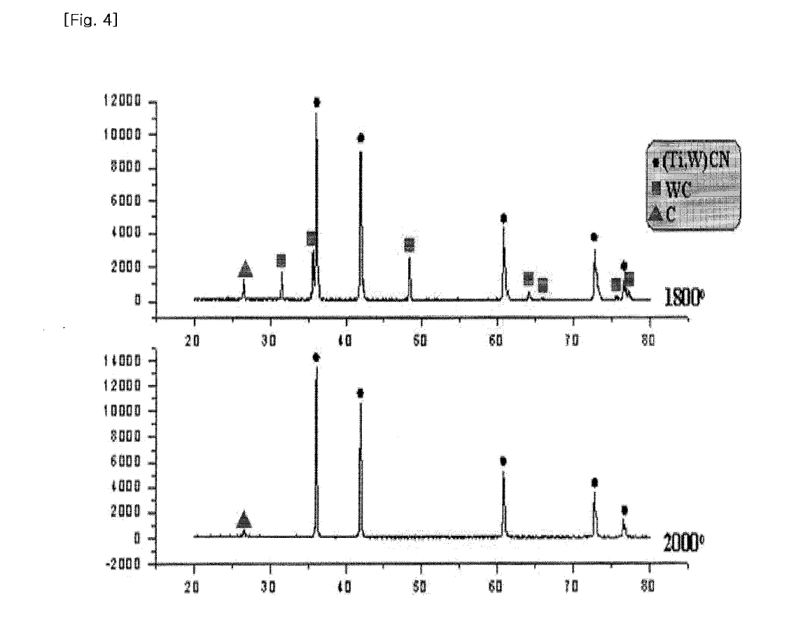

FIG. 4 illustrates XRD results of the (Ti_{0.7}W_{0.3})(CN) solid solution powders prepared by reducing and carbonitriding the powders of FIG. 1(a) and FIG. 1(b) in a graphite vacuum furnace at a nitrogen pressure of 10 torr at 1,800° C. and 2,000° C. for 1 hour, and shows that the (Ti_{0.7}W_{0.3})(CN) complete solid solutions were formed at 1,800° C. and 2,000° C. However, WC and free carbon were precipitated at 1,800° C. since the solid solubility of WC in (Ti,W)(CN) decreased due to the presence of nitrogen, whereas (Ti,W)(CN) complete solid solution powders having free carbon were obtained without formation of WC at 2,000° C.

Table 4 shows the oxygen and carbon contents of the powders prepared by using the above-mentioned compositions and carbonitridation process. The oxygen content was about 0.1 wt % at 1,800° C., and a minimized value of below 0.08 wt % at 2,000° C. Overall oxygen content decreased with increase of temperature.

It can be known from Example 3 that a complete solid solution such as (Ti_{0.7}W_{0.3})(CN) can be easily obtained by reducing and carbonitring at more than 1,800° C. for more than 1 hour. Further, even when utilizing a grinder which provides ununiform grinding results, such as an attrition mill as in Example 1, a solid solution powder which is usable can be prepared by controlling an amount of carbon and carrying out reduction and carbonitriding at more than 1,800° C. Consequently, carbonitride solid solution powders can be prepared at a temperature range of 1,300° C. to 2,200° C., at which a graphite electric furnace operates. It can be also known from Example 3 that, in the case of preparation of carbonitride solid solutions at high temperature (>1,800° C.) for short time (˜1 hour), WC is easily formed and homogenizing temperature of a carbonitride solid solution are higher than that of a carbide solid solution due to a disaffinity between W and nitrogen and presence of free carbon. The fact that free carbon is easily present is a proof that at a high temperature (>1,800° C.), reduction easily takes place despite short reduction time (about 1 hour) and without carbon (formation of CO).

TABLE 4

carbon content (oxygen content)

| raw materials | 1,800° C., 1 hr | 2,000° C., 1 hr |
|---|---|---|
| TiO₂ + WO₃ + C | 12.03 (0.114) | 12.35 (0.075) |

### Example 4

In order to produce a complete solid solution with the composition of (Ti_{0.7}W_{0.3})C-20 wt % Ni, TiO₂, WO₃ and carbon powder were mixed and then ground in an attrition mill, using WC—Co balls, at 250 rpm and with BPR (ball-to-powder ratio) of 30:1, in a dry state for 20 hours. Then, the ground powders were reduced and carburized by heat-treatment at 1,300° C. to 1,500° C. for 2 hours, and at 1,600° C. for 1 hour at a nitrogen pressure of 10 torr to produce (Ti_{0.7}W_{0.3})C solid solution powders. The weights of raw materials used are the same as in Table 1. The solid solution powders were mixed with micrometer-sized Ni powders in a planetary mill in a wet state for 24 hours, and then dried. The dry powders were sintered in a graphite vacuum furnace at 1,510° C. for 1 hour to produce a sintered body.

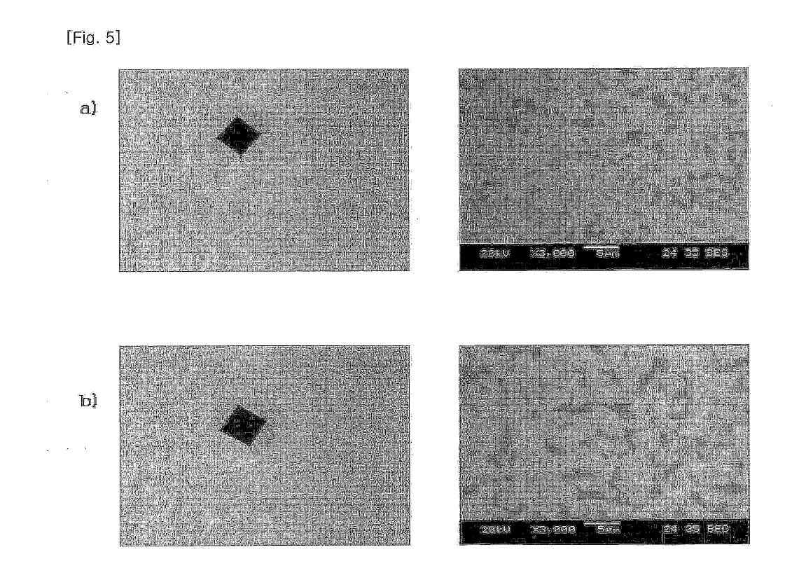

FIG. 5 illustrates optical microscopic and FESEM (field emission scanning microscopy) images of the microstructures of the (Ti_{0.7}W_{0.3})C-20 wt % Ni cermet sintered bodies which were produced by using the (Ti_{0.7}W_{0.3})C solid solution powders, according to Example 4 of the present invention.

FIG. 5(a) depicts optical microscopic and FESEM images of the microstructures of the cermet prepared by sintering at 1,510° C. the (Ti,W)C—Ni powders produced by using solid solutions reduced and carburized at 1,400° C., and shows that the sizes of the solid solutions were about 1 μm to about 3 μm and the sinterability of the solid solution was great. FIG. 5(b) depicts optical microscopic and FESEM images of the microstructures of the cermet prepared by sintering at 1,510° C. the (Ti,W)C—Ni powders produced by using solid solutions reduced and carburized at 1,500° C., and shows that the sizes of the solid solutions were about 2 μm to about 4 μm and the solid solutions have uniform and pore-free microstructures. The powders prepared by reducing and carburizing at higher temperature became larger after sintering. Short lengths of cracks around Vicker's indents which are shown black in FIGS. 5(a) and (b), proves that toughness of (Ti,W)C—Ni sintered body is significantly high.

Table 5 and 6 shows the hardness, toughness and porosity of the cermet produced by compacting (Ti_{0.7}W_{0.3})C-20 wt % Ni cermet powders prepared by using the solid solution powders produced by reduction and carburization at 1,300° C. to 1,500° C. for 1 hour to 2 hours, followed by sintering the compacts at 1,400° C. for 1 hour, and 1,510° C. for 1 hour, respectively. Mechanical property and porosity changed with the reduction and carburization temperature and the sintering temperature. The cermets produced had a low porosity (A2B2) and high toughness, as reduction and carburization temperature increased in the case of low sintering temperature and vice versa.

TABLE 5
Sintering at 1,400° C.

reduction and carburization temperature

| | 1,300° C., | 1,400° C., | 1,500° C., | 1,600° C., |
|---|---|---|---|---|
| | 2 hr | 2 hr | 2 hr | 1 hr |
| H_{V} | 11.2 | 10.9 | 10.2 | 10.1 |
| K_{IC} | 9.3 | 14.1 | 14.3 | 16.1 |
| porosity | A4B3 | A1B1 | A2B3 | A2B1 |

TABLE 6
Sintering at 1,510° C.

reduction and carburization temperature

| | 1,300° C., | 1,400° C., | 1,500° C., | 1,600° C., |
|---|---|---|---|---|
| | 2 hr | 2 hr | 2 hr | 1 hr |
| H_{V} | 10.7 | 11.6 | 9.8 | 9.4 |
| K_{IC} | 14.6 | 11.2 | 13.1 | 13.3 |
| porosity | A3B3 | A2B2 | A3B2 | A5B4 |

### Example 5

In order to produce a complete solid solution with the composition of (Ti_{0.7}W_{0.3})(CN)-20 wt % Ni, TiO₂, WO₃ and carbon powder (TiO₂:Ti=1:0) were mixed and then ground in an attrition mill, using WC—Co balls, at 250 rpm and with BPR (ball-to-powder ratio) of 30:1, in a dry state for 20 hours. Then, the ground powders were reduced, carburized and nitrided by heat-treatment at 1,300° C. to 1,500° C. for 2 hours under vacuum to produce (Ti_{0.7}W_{0.3})(CN) solid solution powders. The weights of raw materials used are the same as in Table 1. The solid solution powders were mixed with micrometer-sized Ni powders in a planetary mill in a wet state for 24 hours, and then dried. The dry powders were sintered in a graphite vacuum furnace at 1,400° C. and 1,510° C. for 1 hour to produce sintered bodies.

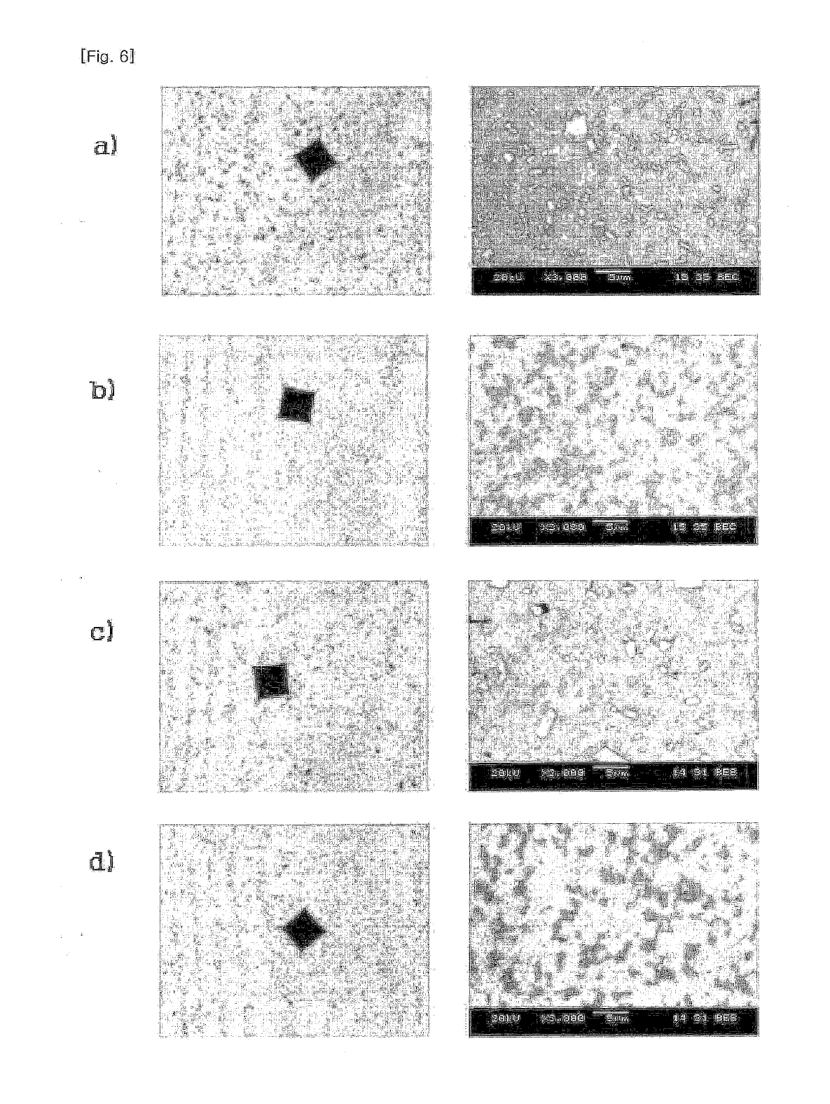

FIG. 6 illustrates optical microscopic and FESEM images of the microstructures of the (Ti_{0.7}W_{0.3})(CN)-20 wt % Ni cermet sintered bodies which were produced by using the (Ti_{0.7}W_{0.3})(CN) solid solution powders prepared according to Example 5 of the present invention.

FIG. 6(a) shows that WC was formed in the microstructure of the cermet sintered body prepared by sintering at 1,400° C. the solid solution powders produced by reduction and carbonitridation at 1,400° C. for 2 hours. FIG. 6(b) shows that WC was not formed in the microstructure of the cermet sintered body prepared by sintering at 1,400° C. the solid solution powders produced by reduction and carbonitridation at 1,500° C. for 2 hours. The porosities of the two sintered bodies were both great (A2B2).

FIG. 6(c) shows that WC was formed in the microstructure of the cermet sintered body prepared by sintering at 1,510° C. the solid solution powders produced by reduction and carbonitridation at 1,400° C. for 2 hours. FIG. 6(d) shows that WC was not formed in the microstructure of the cermet sintered body prepared by sintering at 1,510° C. the solid solution powders produced by reduction and carbonitridation at 1,500° C. for 2 hours. The porosities of the two sintered bodies were both great (A3B3) and, however, were less than those of the sintered bodies sintered at 1,400° C. (FIGS. 5(a) and 5(b)). Short lengths of cracks around Vicker's indents which are shown black in FIG. 6(a) to (d), proves that toughness of (Ti,W)(CN)—Ni sintered body is significantly high.

Table 7 and 8 shows the hardness, toughness and porosity of the cermet produced by compacting (Ti_{0.7}W_{0.3})C-20 wt % Ni cermet powders prepared by using the solid solution powders produced by reduction and carbonitridation at 1,300° C. to 1,500° C. for 2 hours, followed by sintering the compacts at 1,400° C. for 1 hour, and 1,510° C. for 1 hour, respectively. Although mechanical property and porosity changed with the reduction and carburization temperature, the cermets produced generally had a low porosity (A2B2) and high toughness.

TABLE 7
Sintering at 1,400° C.

reduction and carburization temperature

| | 1,300° C., | 1,400° C., | 1,500° C., |
|---|---|---|---|
| | 2 hr | 2 hr | 2 hr |
| H_{V} | 9.2 | 10.2 | 10.6 |
| K_{IC} | 8.4 | 11.5 | 14.2 |
| porosity | A3B5 | A2B2 | A2B2 |

TABLE 8
Sintering at 1,510° C.

reduction and carburization temperature

| | 1,300° C., | 1,400° C., | 1,500° C., |
|---|---|---|---|
| | 2 hr | 2 hr | 2 hr |
| H_{V} | 9.1 | 9.7 | 10.3 |
| K_{IC} | 10.7 | 13.9 | 13.01 |
| porosity | A3B6 | A3B3 | A3B3 |

### Example 6

In order to produce a complete solid solution with the composition of (Ti_{0.7}W_{0.3})(CN)-20 wt % Ni, TiO₂, WO₂ and carbon powder were mixed and then ground in an attrition mill, using WC—Co balls, at 250 rpm and with BPR (ball-to-powder ratio) of 30:1, in a dry state for 20 hours. Then, the ground powders were reduced, carburized and nitrided by heat-treatment at 1,800° C. to 2,000° C. for 1 hour at a nitrogen pressure of 10 torr to produce (Ti_{0.7}W_{0.3})(CN) solid solution powders. The solid solution powders were mixed with micrometer-sized Ni powders in a planetary mill in a wet state for 24 hours, and then dried. The dry powders were sintered in a graphite vacuum furnace at 1,400° C. and 1,510° C. for 1 hour to produce sintered bodies.

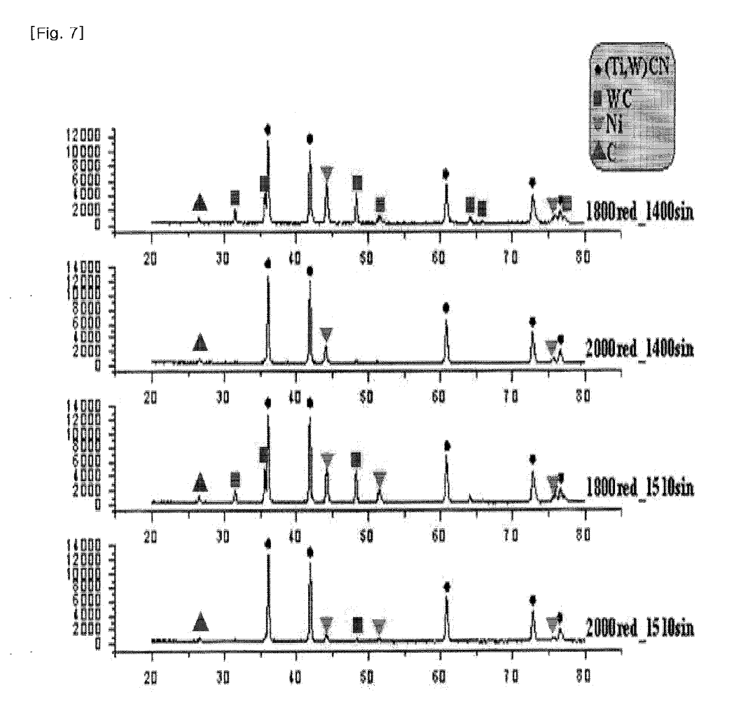

FIG. 7 illustrates XRD results of the (Ti_{0.7}W_{0.3})(CN)-20 wt % Ni cermet sintered bodies which were produced by using the (Ti_{0.7}W_{0.3})(CN) solid solution powders prepared according to Example 6 of the present invention. FIG. 7 shows that the sintered body prepared by reducing, carburizing and nitriding through heat-treating at 2,000° C. for 1 hour followed by sintering, was formed as (Ti_{0.7}W_{0.3})(CN) complete solid solution, regardless of sintering temperature. However, in the sintered body prepared by reducing, carburizing and nitriding through heat-treating at 1,800° C. for 1 hour followed by sintering, WC in addition to (Ti,W)(CN) was precipitated and free carbon was also observed due to the short reduction time and presence of nitrogen.

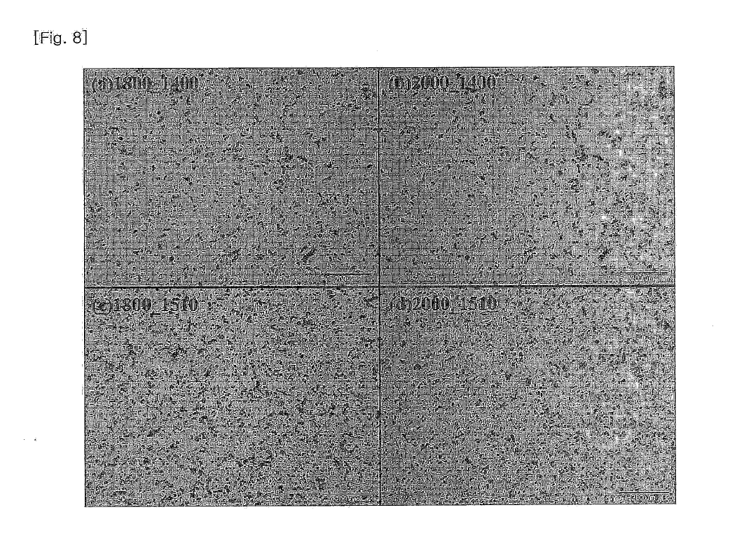

FIG. 8 illustrates optical microscopic images of the microstructures of the (Ti_{0.7}W_{0.3})(CN)-20 wt % Ni cermet sintered bodies which were produced by using the (Ti_{0.7}W_{0.3})(CN) solid solution powders prepared according to Example 6 of the present invention. FIG. 8(a) shows the cermet sintered body prepared by sintering at 1,400° C. the solid solution powders produced by reducing and carbonitriding at 1,800° C. for 1 hour, in which WC was precipitated in the microstructure of the cermet sintered body and many pores were observed. FIG. 8(b) shows the cermet sintered body prepared by sintering at 1,400° C. the solid solution powders produced by reducing and carbonitriding at 2,000° C. for 1 hour, in which WC was not precipitated in the microstructure of the cermet sintered body but many pores due to free carbon were observed. Both the above cases were worse, in respect of the porosity and the control of a complete solid solution phase, than the cermet sintered bodies prepared by sintering at 1,400° C. the solid solution powders produced by reducing and carbonitriding at 1,300° C. to 1,600° C. for 2 hours. FIG. 8(c) shows the cermet sintered body prepared by sintering at 1,510° C. the solid solution powders produced by reducing and carbonitriding at 1,800° C. for 1 hour, in which WC and free carbon were precipitated in the microstructure of the cermet sintered body. FIG. 8(d) shows the cermet sintered body prepared by sintering at 1,510° C. the solid solution powders produced by reducing and carbonitriding at 2,000° C. for 1 hour, in which WC was not precipitated due to high reduction temperature but free carbon were present. Both the above cases were worse, in respect of the porosity and the control of a complete solid solution phase, than the cermet sintered bodies prepared by sintering at 1,510° C. the solid solution powders produced by reducing and carbonitriding at 1,300° C. to 1,600° C. for 2 hours.

High porosity in the microstructure is due to free carbon. Since reduction by decomposition of oxides takes place actively without formation of CO (consumption of carbon) in the case of preparation of carbonitride solid solutions at high temperature (>1,800° C.) within short period (˜1 hour), the required amount of carbon is less than in Table 1. As a result, sintered body without pores and WC can be produced when process conditions are optimized depending on temperature and size of a graphite vacuum furnace.

According to the above-mentioned Examples of the present invention, even when utilizing a grinder which provides ununiform grinding results, such as an attrition mill, suitable solid solution powders can be prepared by controlling an amount of carbon and carrying out reduction and carburizing and/or nitriding at more than 1,300° C. Therefore, carbonitride solid solution powders can be prepared at a temperature range of 1,300° C. to 2,200° C., at which a graphite electric furnace operates.

### Example 7

In order to produce (Ti_{0.7}W_{0.3})C-15˜20 wt % Ni and (Ti_{0.7}W_{0.3})C-15˜20 wt % Ni cermet sintered bodies, TiO₂, WO₃ and carbon powder were mixed in accordance with the compositions of the above Examples, and then ground in an attrition mill, using WC—Co balls, at 250 rpm and with BPR of 30:1, in a dry state for 20 hours. Then, the ground powders were reduced and carburized by heat-treatment at 1,400° C. for 2 hours under vacuum to produce (Ti_{0.7}W_{0.3})C and (Ti_{0.88}W_{0.12})C solid solution powders, respectively, and the formation of complete solid solutions was confirmed by using XRD. The solid solution powders were mixed with micrometer-sized Ni powders in a planetary mill in a wet state for 24 hours, and then dried. The dry powders were presintered in a graphite vacuum furnace at 1,300° C. for 0.5 hours to produce a sintered body, and then were sintered by using a gas pressure sintering (GPS) furnace at argon atmosphere of 60 atm for 1 hour to produce sintered bodies.

FIG. 9 illustrates optical microscopic images of the microstructures of the (Ti₁₋ₓWₓ)C-15˜20 wt % Ni cermet sintered bodies which were produced by using the (Ti_{0.7}W_{0.3})C and (Ti_{0.88}W_{0.12})C solid solution powders prepared according to Example 7 of the present invention.

FIG. 9(a) shows optical microscopic images of the (Ti_{0.7}W_{0.3})C-15, 18, 20 wt % Ni cermet sintered bodies which were produced by sintering, through GPS, the mixture of Ni with (Ti_{0.7}W_{0.3})C powders prepared by reduction and carburization at 1,400° C., in which excellent sinterability was observed. FIG. 9(b) shows optical microscopic images of the (Ti_{0.88}W_{0.12})C-15, 18, 20 wt % Ni cermet sintered bodies which were produced by sintering, through GPS, the mixture of Ni with (Ti_{0.88}W_{0.12})C powders pprepared by reduction and carburization at 1,400° C., in which many pores and free carbon were observed in the microstructure of the sintered body. (Ti_{0.88}W_{0.12})C solid solution powders to which the amounts of carbon added were determined by the same way as described in Example 1 (Table 1) for the preparation of (Ti_{0.7}W_{0.3})C solid solution powders, generally had free carbon.

Table 9 and 10 shows the hardness, toughness and porosity of the (Ti_{0.7}W_{0.3})C-15˜20 wt % Ni (Table 9) and (Ti_{0.88}W_{0.12})C-15˜20 wt % Ni (Table 10) cermet sintered bodies produced by compacting the solid solution powders prepared by reduction and carbonitridation at 1,400° C. for 2 hours, and then presintering the compacts in a GPS furnace at 1,300° C. for 0.5 hours, and finally sintering the presintered compacts at argon atmosphere of 60 atm at 1,400° C. for 1 hour, according to the method of Example 7. It was shown that the mechanical property and porosity of the cermet sintered body changed according to the tungsten content, i.e., composition of the complete solid solution. As the amount of the binder phase (Ni) increases, toughness increases and hardness decreases in the case of (Ti_{0.7}W_{0.3})C-15˜20 wt % Ni. (Ti_{0.7}W_{0.3})C-15˜20 wt % Ni has lower porosity (<A2B2) and higher toughness than (Ti_{0.88}W_{0.12})C-15˜20 wt % Ni. However, the toughness of (Ti_{0.7}W_{0.3})C-15˜20 wt % Ni was lower than that of (Ti_{0.7}W_{0.3})C-15˜20 wt % Ni prepared by vacuum sintering (Example 4, Table 5 and 6). It is expected that the presence of pores and free carbon in (Ti_{0.88}W_{0.12})C-15˜20 wt % Ni can be overcome by controlling the amount of carbon being added, and also toughness will increase. Generally, a sintered body prepared by GPS was inferior to that prepared by vacuum sintering (Example 4, Table 5 and 6), in respect of mechanical properties.

TABLE 9
(Ti_{0.7}W_{0.3})C-15~20 wt % Ni: GPS (gas pressure sintering)

amount of a binder phase (Ni)

| | 15 wt % | 18 wt % | 20 wt % |
|---|---|---|---|
| Hᵥ | 11.5 | 11.1 | 10.6 |
| K_{1C} | 9.5 | 10.6 | 10.8 |
| porosity | A1B1 | A1B1 | A1B1 |

TABLE 10
(Ti_{0.88}W_{0.12})C-15~20 wt % Ni: GPS

amount of a binder phase (Ni)

| | 15 wt % | 18 wt % | 20 wt % |
|---|---|---|---|
| Hᵥ | 10.1 | 9.3 | 8.8 |
| K_{1C} | — | — | — |
| porosity | — | — | — |

### Example 8

In order to produce (Ti_{0.7}W_{0.3})(CN)-15˜20 wt % Ni and (Ti_{0.88}W_{0.12})(CN)-15˜20 wt % Ni cermet sintered bodies, TiO₂, WO₃ and carbon powder were mixed in accordance with the compositions of the above Examples, and then ground in an attrition mill, using WC—Co balls, at 250 rpm and with BPR of 30:1, in a dry state for 20 hours. Then, the ground powders were reduced and carbonitrided by heat-treatment at 1,400° C. for 2 hours under vacuum to produce (Ti_{0.7}W_{0.3})(CN) and (Ti_{0.88}W_{0.12})(CN) solid solution powders, respectively, and the formation of complete solid solutions was confirmed by using XRD. The solid solution powders were mixed with micrometer-sized Ni powders in a planetary mill in a wet state for 24 hours, and then dried. The dry powders were sintered in a graphite vacuum furnace at 1,400° C. for 1 hour to produce sintered bodies.

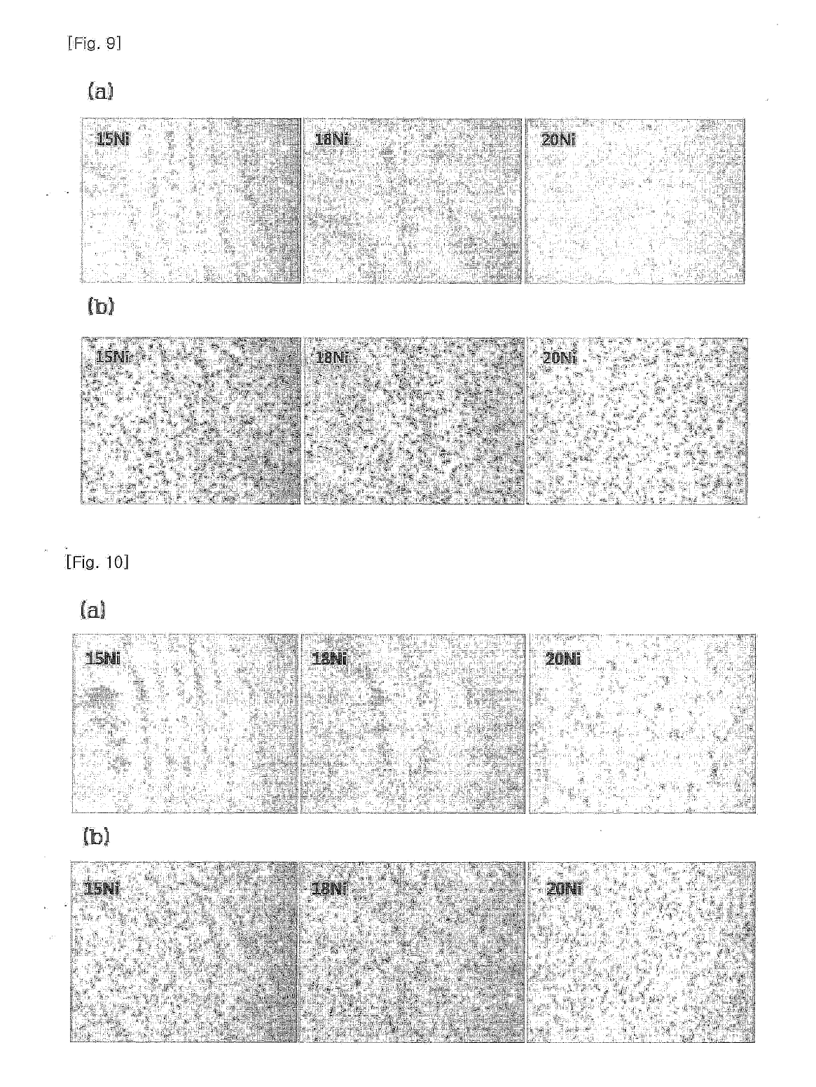

FIG. 10 illustrates optical microscopic images of the microstructures of the (Ti₁₋ₓWₓ)(CN)-15˜20 wt % Ni cermet sintered bodies which were produced by using the (Ti_{0.7}W_{0.3})(CN) and (Ti_{0.88}W_{0.12})(CN) solid solution powders prepared according to Example 8 of the present invention.

FIG. 10(a) shows optical microscopic images of the (Ti_{0.7}W_{0.3})(CN)-15, 18, 20 wt % Ni cermet sintered bodies which were produced by sintering the mixture of Ni with (Ti_{0.7}W_{0.3})(CN) powders prepared by reduction and carbonitridation at 1,500° C., in which excellent sinterability was observed. FIG. 10(b) shows optical microscopic images of the (Ti_{0.88}W_{0.12})(CN)-15, 18, 20 wt % Ni cermet sintered bodies which were produced by sintering the mixture of Ni with (Ti_{0.88}W_{0.12})(CN) powders prepared by reduction and carbonitridation at 1,500° C., in which many pores and free carbon were observed in the microstructure of the sintered body. (Ti_{0.88}W_{0.12})(CN) solid solution powders also had free carbon as (Ti_{0.88}W_{0.12})C solid solution powders in Example 7.

Table 11 and 12 shows the hardness, toughness and porosity of the (Ti_{0.7}W_{0.3})(CN)-15˜20 wt % Ni (Table 11) and (Ti_{0.88}W_{0.12})(CN)-15˜20 wt % Ni (Table 12) cermet sintered bodies produced by compacting the solid solution powders prepared by reduction and carbonitridation at 1,500° C. for 2 hours, and then sintering the compacts at 1,400° C. for 1 hour, according to the method of Example 8. It was shown that the mechanical property and porosity of the cermet sintered body changed according to the tungsten content, i.e., composition of the complete solid solution. (Ti_{0.7}W_{0.3})(CN)-15˜20 wt % Ni has lower porosity (<A2B2) and higher toughness than (Ti_{0.88}W_{0.12})(CN)-15˜20 wt % Ni. As the amount of the binder phase (Ni) increases, toughness increases and hardness decreases in the case of (Ti_{0.7}W_{0.3})(CN)-15˜20 wt % Ni. It is expected that the presence of pores and free carbon in (Ti_{0.88}W_{0.12})(CN)-15˜20 wt % Ni can be overcome by controlling the amount of carbon being added, and also toughness will increase.

TABLE 11
\grave{ }(Ti_{0.7}W_{0.3})(CN)-15~20 wt % Ni: sintering at 1400° C. for 1 hour

amount of a binder phase (Ni)

| | 15 wt % | 18 wt % | 20 wt % |
|---|---|---|---|
| Hᵥ | 10.8 | 10.2 | 9.7 |
| K_{1C} | 12.6 | 12.0 | 12.3 |
| porosity | A2B2 | A2B2 | A2B3 |

TABLE 12
(Ti_{0.88}W_{0.12})(CN)-15~20 wt % Ni: sintering at 1400° C. for 1 hour

amount of a binder phase (Ni)

| | 15 wt % | 18 wt % | 20 wt % |
|---|---|---|---|
| Hᵥ | 11.8 | 10.9 | 10.7 |
| K_{1C} | — | — | — |
| porosity | — | — | — |

### Example 9

In order to produce a complete solid solution with the composition of (Ti_{0.7}W_{0.3})C, Ti metal, anatase TiO₂, WO₃ and carbon powder were prepared. The mixtures in which the mixture ratios of TiO₂ and Ti were 4:1, were prepared, and WO₃ and carbon powder were mixed therewith. The thus prepared mixtures were ground in an attrition mill, using WC—Co balls, at 200 rpm and with BPR (ball-to-powder ratio) of 30:1, in a dry state for 5, 10 and 20 hours, and then were reduced and carburized by heat-treatment at 1,300° C. to 1,500° C. for 2 hours, and at 1,600° C. for 1 hour under vacuum.

Considering that most reduction procedures proceed with the emission of CO gases, the amount of carbon being added was determined based on the calculation that 3 moles carbon per 1 mole TiO₂ is required when TiO₂ is used to produce carbide, and 1 mole carbon per 1 mole Ti is required when Ti is used to produce carbide. Residual carbon was additionally added by 1 wt %. The weights of raw materials used to prepare the target composition of (Ti_{0.7}W_{0.3})C are listed in Table 13.

TABLE 13

| | |
|---|---|
| TiO₂:Ti | raw materials (g/66 g batch) |

| weight ratio | TiO₂ | Ti | WO₃ | C |
|---|---|---|---|---|
| 4:1 | 16.96 | 4.24 | 29.89 | 15.35 |

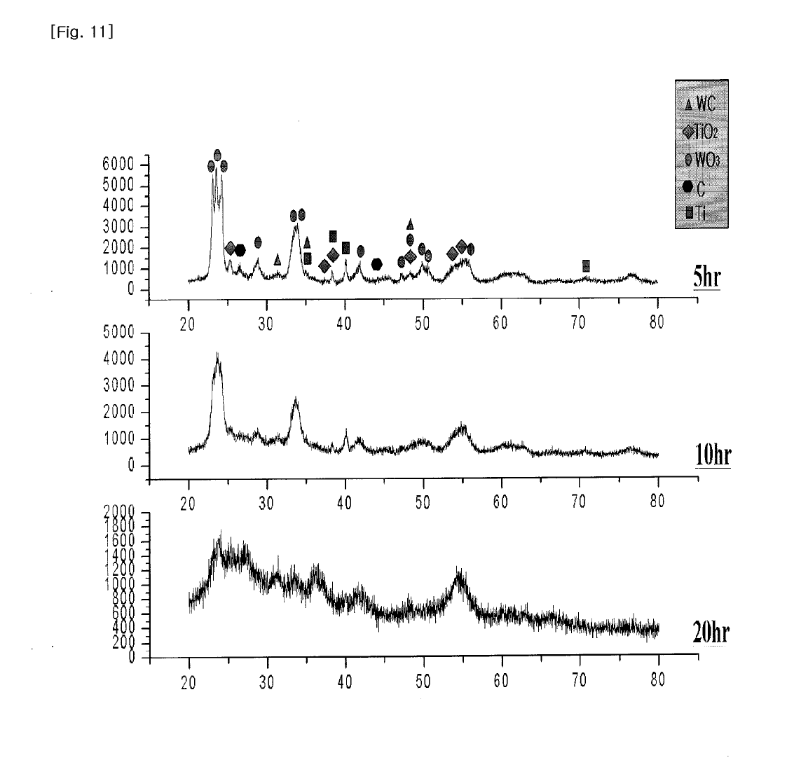

FIG. 11 illustrates graphs of XRD phase analysis results of the powders prepared by mixing Ti, anatase TiO₂, WO₃ and C powders in which the ratio of TiO₂:Ti is 4:1, and grinding the mixture in a planetary mill for 5, 10 and 20 hours, respectively, according to Example 9 of the present invention. It is seen that each phase was still present after grinding for 5 hours. The peak of each phase disappeared after grinding for 10 and 20 hours and, therefore, it can be understood that oxides had changed into nanocrystallite or amorphous form after grinding.

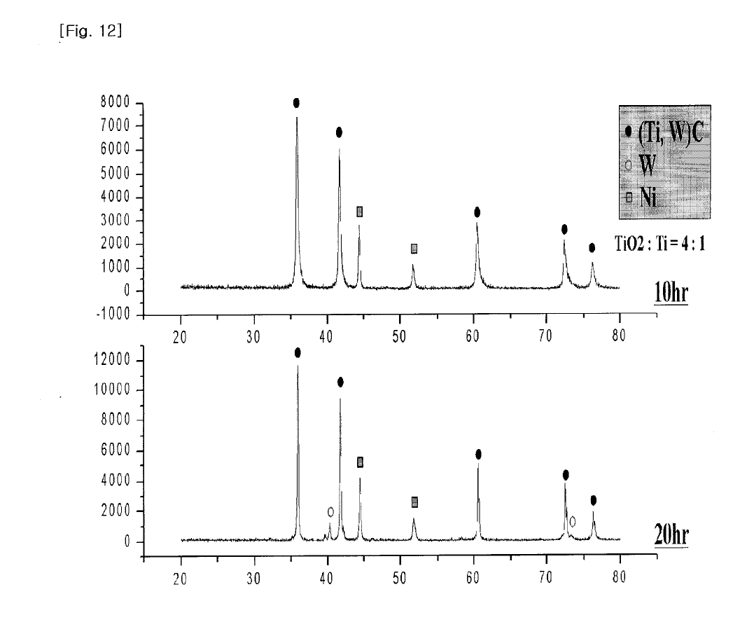

FIG. 12 illustrates XRD results of the powders prepared by mixing Ti, anatase TiO₂, WO₃ and C powders in which the ratio of TiO₂:Ti is 4:1, grinding the mixture in a planetary mill for 5, 10 and 20 hours, respectively, and carburizing and reducing the ground powders in a graphite vacuum furnace at 1,300° C. for 2 hours, according to Example 9 of the present invention. It can be known that a complete solid solution was formed after grinding for 10 hours, and tungsten was precipitated, together with a complete solid solution phase, due to lack of carbon after grinding for 20 hours.

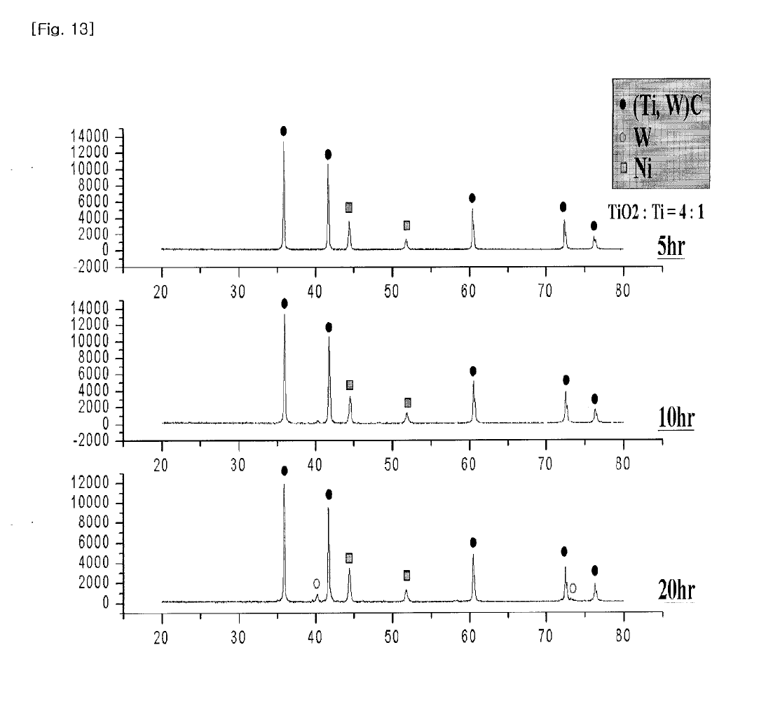

FIG. 13 illustrates XRD results of the powders prepared by mixing Ti, anatase TiO₂, WO₃ and C powders in which the ratio of TiO₂:Ti is 4:1, grinding the mixture in a planetary mill for 5, 10 and 20 hours, respectively, and carburizing and reducing the ground powders in a graphite vacuum furnace at 1,400° C. for 2 hours, according to Example 9 of the present invention. It can be known that a complete solid solution was formed after grinding for 5 and 10 hours, and tungsten was precipitated, together with a complete solid solution phase, due to lack of carbon after grinding for 20 hours.

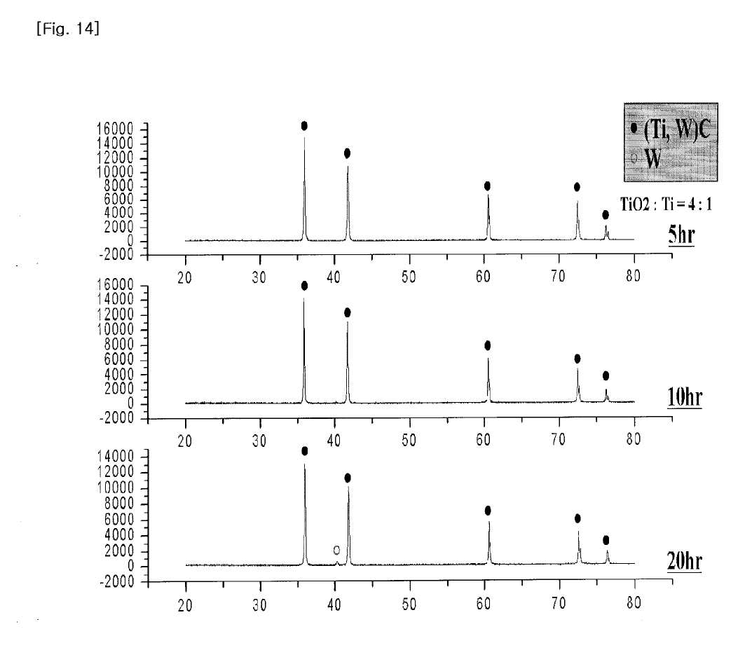

FIG. 14 illustrates XRD results of the powders prepared by mixing Ti, anatase TiO₂, WO₃ and C powders in which the ratio of TiO₂:Ti is 4:1, grinding the mixture in a planetary mill for 5, 10 and 20 hours, respectively, and carburizing and reducing the ground powders in a graphite vacuum furnace at 1,500° C. for 2 hours, according to Example 9 of the present invention. It can be known that a complete solid solution was formed after grinding for 5 and 10 hours, and tungsten was precipitated, together with a complete solid solution phase, due to lack of carbon after grinding for 20 hours.

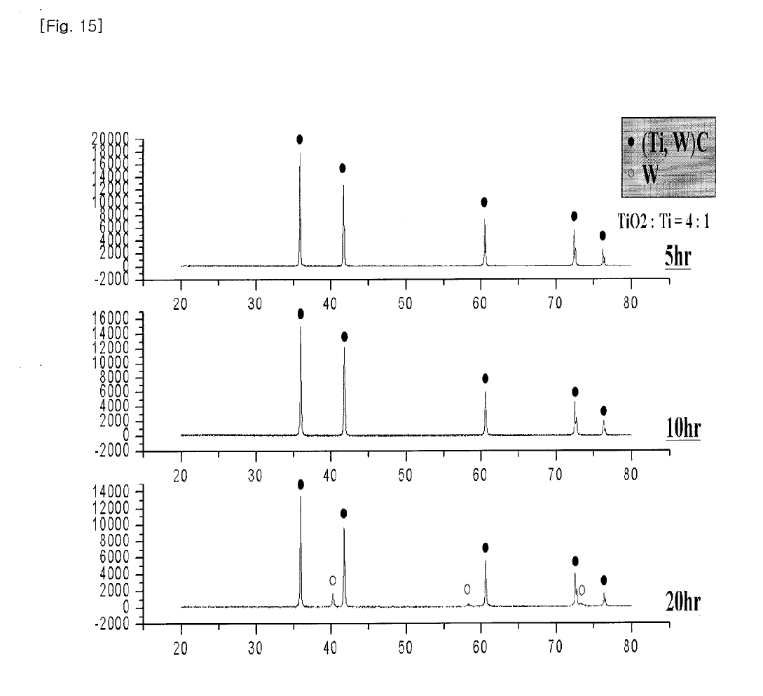

FIG. 15 illustrates XRD results of the powders prepared by mixing Ti, anatase TiO₂, WO₃ and C powders in which the ratio of TiO₂:Ti is 4:1, grinding the mixture in a planetary mill for 5, 10 and 20 hours, respectively, and carburizing and reducing the ground powders in a graphite vacuum furnace at 1,600° C. for 2 hours, according to Example 9 of the present invention. It can be known that a complete solid solution was formed after grinding for 5 and 10 hours, and tungsten was precipitated, together with a complete solid solution phase, due to lack of carbon after grinding for 20 hours.

The above results show that (Ti_{0.7}W_{0.3})C complete solid solution was formed by mixing Ti, anatase TiO₂, WO₃ and C powders in which the ratio of TiO₂:Ti is 4:1, grinding the mixture in a planetary mill, and then reducing and carburizing the ground powders at a temperature range of 1,300° C. to 1,600° C. In addition, only (Ti_{0.7}W_{0.3})C complete solid solution was formed in the case of the powders prepared by grinding raw materials for a relatively short time, namely 5 or 10 hours, and then reducing and carburizing the ground powders, and W, together with (Ti_{0.7}W_{0.3})C complete solid solution, was formed due to lack of carbon in the case of the powders prepared by grinding raw materials for 20 hours, and then reducing and carburizing the ground powders.

The oxygen and carbon contents of the powders prepared by using process of Example 9 are shown in Table 14. When reducing and carburizing at temperatures of more than 1,300° C., the oxygen contents were all appropriate. Especially when reducing and carburizing at temperatures of more than 1,400° C., the residual oxygen is so low as to be less than 0.5 wt %. When a planetary mill was used, the carbon content decreased with decrease of milling time and with increase of temperature.

TABLE 14

| raw | carbon content (oxygen content; weight ratio) | | | | | | | | | | |
|---|---|---|---|---|---|---|---|---|---|---|---|
| materials | 1,300° C., 2 hr | | 1,400° C., 2 hr | | | 1,500° C., 2 hr | | | 1,600° C., 1 hr | | |
| milling time | 10 hr | 20 hr | 5 hr | 10 hr | 20 hr | 5 hr | 10 hr | 20 hr | 5 hr | 10 hr | 20 hr |
| Ti0₂ + Ti + W0₃ + C | 10.47 | 10.00 | 10.81 | 10.51 | 10.02 | 10.93 | 10.27 | 10.20 | 10.83 | 10.58 | 9.92 |
| (Ti0₂:Ti = 4:1) | (0.93) | (0.52) | (0.19) | (0.23) | (0.54) | (0.16) | (0.22) | (0.41) | (0.12) | (0.22) | (0.48) |

It can be known from Example 9 that a complete solid solution such as (Ti_{0.7}W_{0.3})C can be easily obtained when the mixed oxide powders ground, even for a relatively short period of 5˜10 hours, in a planetary mill are reduced and carburized at a temperature of more than 1,300° C. for more than 2 hours. In the case of reduction and carburization at more than 1,400° C. for more than 2 hours, or at more than 1,600° C. for 1 hour, the amount of residual oxygen is very low (<0.5 wt %) and carbon content can be appropriately maintained. Therefore, even when utilizing a high-energy mill which provides uniform grinding results, such as a planetary mill, a solid solution powder can be prepared at a wide range of temperature of 1,300° C. to 2,200° C.

### Example 10

In order to produce a complete solid solution with the composition of (Ti_{0.7}W_{0.3})C-20 wt % Ni, Ti metal, anatase TiO₂, WO₃ and carbon powder were prepared. The mixtures in which the mixture ratios of TiO₂ and Ti were 4:1, were prepared, and WO₃ and carbon powder were mixed therewith. The thus prepared mixtures were ground in an attrition mill, using WC—Co balls, at 200 rpm and with BPR (ball-to-powder ratio) of 30:1, in a dry state for 5, 10 and 20 hours as in Example 9, and then were reduced and carburized by heat-treatment at 1,300° C. to 1,500° C. for 2 hours, and at 1,600° C. for 1 hour under vacuum.

The powders reduced and carburized at 1,300° C. and 1,400° C. for 2 hours were sintered at 1,510° C. for 1 hour, and the powders reduced and carburized at 1,500° C. and 1,600° C. for 2 hours and 1 hour, respectively, were sintered at 1,400° C. for 1 hour in a graphite vacuum furnace. Considering that most reduction procedures proceed with the emission of CO gases, the amount of carbon being added was determined based on the calculation that 3 moles carbon per 1 mole TiO₂ is required when TiO₂ is used to produce carbide, and 1 mole carbon per 1 mole Ti is required when Ti is used to produce carbide. Residual carbon was additionally added by 1 wt %.

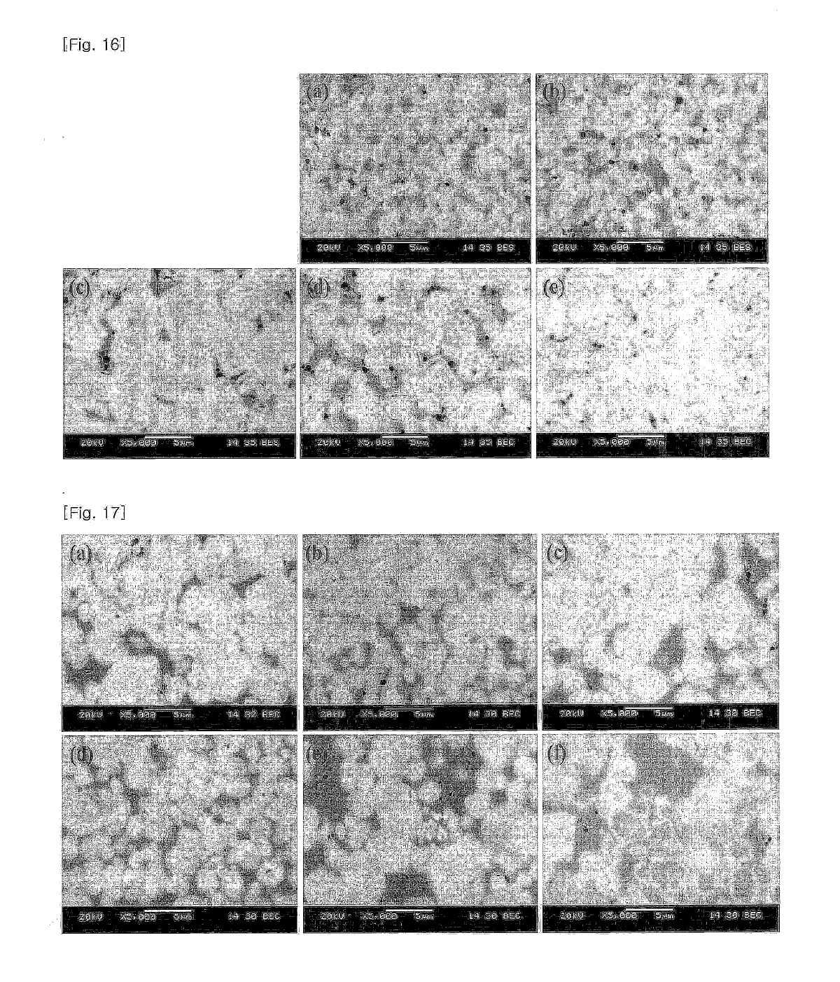

FIG. 16 illustrates SEM images of the microstructures of the sintered bodies prepared by sintering the (Ti_{0.7}W_{0.3})C-20 wt % Ni cermet powders at 1,510° C. for 1 hour under vacuum, according to Example 10 of the present invention.

FIGS. 16(a) and (b) show SEM images of the (Ti_{0.7}W_{0.3})C-20 wt % Ni sintered bodies produced by sintering, at 1,510° C. for 1 hour under vacuum, the (Ti_{0.7}W_{0.3})C—Ni cermet powders prepared by reduction and carburization of the ground powders at 1,300° C. for 2 hours after grinding raw materials in a planetary mill for 10 and 20 hours, respectively, and also show complete solid solution phases together with fine pores (<0.5 wt %). FIG. 16(c), (d) and (e) show SEM images of the (Ti_{0.7}W_{0.3})C-20 wt % Ni sintered bodies produced by sintering, at 1,510° C. for 1 hour under vacuum, the (Ti_{0.7}W_{0.3})C—Ni cermet powders prepared by reduction and carburization of the ground powders at 1,400° C. for 2 hours after grinding raw materials in a planetary mill for 5, 10 and 20 hours, respectively, and also show complete solid solution phases together with fine pores (<0.5 wt %).

FIG. 17 illustrates SEM images of the microstructures of the sintered bodies prepared by sintering the (Ti_{0.7}W_{0.3})C-20 wt % Ni cermet powders at 1,400° C. for 1 hour under vacuum, according to Example 10 of the present invention.

FIG. 17(a), (b) and (c) show SEM images of the (Ti_{0.7}W_{0.3})C-20 wt % Ni sintered bodies produced by sintering, at 1,400° C. for 1 hour under vacuum, the (Ti_{0.7}W_{0.3})C—Ni cermet powders prepared by reduction and carburization of the ground powders at 1,500° C. for 2 hours after grinding raw materials in a planetary mill for 5, 10 and 20 hours, respectively, and also show complete solid solution phases together with fine pores (<0.5 wt %). FIG. 17(d), (e) and (f) show SEM images of the (Ti_{0.7}W_{0.3})C-20 wt % Ni sintered bodies produced by sintering, at 1,400° C. for 1 hour under vacuum, the (Ti_{0.7}W_{0.3})C—Ni cermet powders prepared by reduction and carburization of the ground powders at 1,600° C. for 1 hour after grinding raw materials in a planetary mill for 5, 10 and 20 hours, respectively, and also show complete solid solution phases together with fine pores (<0.5 wt %).

1. A complete solid solution powder prepared by the steps comprising:
i) step 1 of mixing, or mixing and grinding at least two metals, including Ti, selected from the group consisting of Ti, Zr, Hf, V, Nb, Ta, Cr, Mo and W, oxides of said at least two metals, and carbon powder; and
ii) step 2 of reducing and carburizing, or reducing, carburizing and nitriding said mixed, or mixed and ground powder.

2. The Complete solid solution powder of claim 1, wherein said powder is reduced and carburized at 1,300° C. to 2,200° C. for less than 3 hours under vacuum or hydrogen atmosphere to produce a complete solid solution carbide, or said powder is reduced, carburized and nitrided at 1,300° C. to 2,200° C. for less than 3 hours under nitrogen atmosphere to produce a complete solid solution carbonitride, at the step 2.

3. A sintered body prepared by the steps comprising:
i) step 1 of mixing, or mixing and grinding at least two metals, including Ti, selected from the group consisting of Ti, Zr, Hf, V, Nb, Ta, Cr, Mo and W, oxides of said at least two metals, and carbon powder;
ii) step 2 of reducing and carburizing, or reducing, carburizing and nitriding said mixed, or mixed and ground powder; and
iii) step 3 of compacting and sintering said complete solid solution powder obtained at the step 2.

4. The sintered body of claim 3, wherein said powder is reduced and carburized at 1,300° C. to 2,200° C. for less than 3 hours under vacuum or hydrogen atmosphere to produce a complete solid solution carbide, or said powder is reduced, carburized and nitrided at 1,300° C. to 2,200° C. for less than 3 hours under nitrogen atmosphere to produce a complete solid solution carbonitride, at the step 2.

5. The sintered body of claim 3, wherein said complete solid solution powder is sintered at 1,250° C. to 1,600° C. for 0.1 to 3 hours under vacuum or nitrogen atmosphere at the step 3.

6. A cermet powder prepared by the steps comprising:
i) step 1-2 of mixing, or mixing and grinding at least one oxide selected from the group consisting of nickel, cobalt and iron, at least two metals, including Ti, selected from the group consisting of Ti, Zr, Hf, V, Nb, Ta, Cr, Mo and W, oxides of said at least two metals, and carbon powder; and
ii) step 2-2 of reducing and carburizing, or reducing, carburizing and nitriding said mixed, or mixed and ground powder.

7. The cermet powder of claim 6, wherein said powder is reduced and carburized at 1,100° C. to 1,400° C. for less than 3 hours under vacuum or hydrogen atmosphere to produce a complete solid solution carbide, or said powder is reduced, carburized and nitrided at 1,100° C. to 1,400° C. for less than 3 hours under nitrogen atmosphere to produce a complete solid solution carbonitride, at the step 2-2.

8. A cermet prepared by the steps comprising:
i) step 1-2 of mixing, or mixing and grinding an oxide of at least one selected from the group consisting of nickel, cobalt and iron, at least two metals, including Ti, selected from the group consisting of Ti, Zr, Hf, V, Nb, Ta, Cr, Mo and W, oxides of said at least two metals, and carbon powder;
ii) step 2-2 of reducing and carburizing, or reducing, carburizing and nitriding said mixed, or mixed and ground powder; and
iii) step 2-3 of compacting and sintering said cermet powder obtained at the step 2-2.

9. The cermet of claim 8, wherein said powder is reduced and carburized at 1,100° C. to 1,400° C. for less than 3 hours under vacuum or hydrogen atmosphere to produce a complete solid solution carbide, or said powder is reduced, carburized and nitrided at 1,100° C. to 1,400° C. for less than 3 hours under nitrogen atmosphere to produce a complete solid solution carbonitride, at the step 2-2.

10. The cermet of claim 8, wherein said cermet powder is sintered at 1,250° C. to 1,600° C. for 0.1 to 3 hours under vacuum or nitrogen atmosphere at the step 2-3.

11. A cermet powder prepared by the steps comprising:
i) mixing, or mixing and grinding at least two metals, including Ti, selected from the group consisting of Ti, Zr, Hf, V, Nb, Ta, Cr, Mo and W, oxides of said at least two metals, and carbon powder;
ii) reducing and carburizing, or reducing, carburizing and nitriding said mixed, or mixed and ground powder to prepare a complete solid solution powder; and
iii) adding at least one metal selected from the group consisting of nickel, cobalt and iron to said complete solid solution powder.

12. A method for preparing a cermet comprising:
i) mixing, or mixing and grinding at least two metals, including Ti, selected from the group consisting of Ti, Zr, Hf, V, Nb, Ta, Cr, Mo and W, oxides of said at least two metals, and carbon powder;
ii) reducing and carburizing, or reducing, carburizing and nitriding said mixed, or mixed and ground powder to prepare a complete solid solution powder;
iii) adding at least one metal selected from the group consisting of nickel, cobalt and iron to said complete solid solution powder; and
iv) compacting and sintering said cermet powder obtained from the step iii).

13. The method of claim 12, wherein said powder is reduced and carburized at 1,300° C. to 2,200° C. for less than 3 hours under vacuum or hydrogen atmosphere to produce a complete solid solution carbide, or said powder is reduced, carburized and nitrided at 1,300° C. to 2,200° C. for less than 3 hours under nitrogen atmosphere to produce a complete solid solution carbonitride, at the step ii).

14. The method of claim 12, wherein said sintering of the step iv) is carried out at 1,250° C. to 1,600° C. for 0.1 to 3 hours under vacuum or nitrogen atmosphere.

15. A method for preparing a complete solid solution powder comprising:
i) step 1 of mixing, or mixing and grinding at least two metals, including Ti, selected from the group consisting of Ti, Zr, Hf, V, Nb, Ta, Cr, Mo and W, oxides of said at least two metals, and carbon powder; and
ii) step 2 of reducing and carburizing, or reducing, carburizing and nitriding said mixed, or mixed and ground powder.

16. The method of claim 15, wherein said powder is reduced and carburized at 1,300° C. to 2,200° C. for less than 3 hours under vacuum or hydrogen atmosphere to produce a complete solid solution carbide, or said powder is reduced, carburized and nitrided at 1,300° C. to 2,200° C. for less than 3 hours under nitrogen atmosphere to produce a complete solid solution carbonitride, at the step 2.

17. A method for preparing a cermet powder comprising:
i) step 1-2 of mixing, or mixing and grinding at least one oxide selected from the group consisting of nickel, cobalt and iron, at least two metals, including Ti, selected from the group consisting of Ti, Zr, Hf, V, Nb, Ta, Cr, Mo and W, oxides of said at least two metals, and carbon powder; and
ii) step 2-2 of reducing and carburizing, or reducing, carburizing and nitriding said mixed, or mixed and ground powder.

18. The method of claim 17, wherein said powder is reduced and carburized at 1,100° C. to 1,400° C. for less than 3 hours under vacuum or hydrogen atmosphere to produce a complete solid solution carbide, or said powder is reduced, carburized and nitrided at 1,100° C. to 1,400° C. for less than 3 hours under nitrogen atmosphere to produce a complete solid solution carbonitride, at the step 2-2.

19. A method for preparing a cermet powder comprising:
i) mixing, or mixing and grinding at least two metals, including Ti, selected from the group consisting of Ti, Zr, Hf, V, Nb, Ta, Cr, Mo and W, oxides of said at least two metals, and carbon powder;
ii) reducing and carburizing, or reducing, carburizing and nitriding said mixed, or mixed and ground powder to prepare a complete solid solution powder; and
iii) adding at least one metal selected from the group consisting of nickel, cobalt and iron to said complete solid solution powder.
